(19) United States
(12) Patent Application Publication
(10) Pub. No.: US 2013/0136164 A1
(43) Pub. Date: May 30, 2013

(54) DUMMY PAGING CHANNEL DETECTION

(71) Applicant: Jean-Philippe Ronc, ANTIBES (FR)

(72) Inventor: Jean-Philippe Ronc, ANTIBES (FR)

(73) Assignee: HT mMOBILE INC., Hsinchu (TW)

(21) Appl. No.: 13/304,679

(22) Filed: Nov. 27, 2011

(51) Int. Cl. H04B 17/00

(52) U.S. Cl. 375/224

(57) ABSTRACT

This invention relates to a method and system for detecting a dummy paging channel message. the method includes the steps of: providing a reference dummy paging channel burst sequence; receiving a plurality of raw burst data; comparing every bits of the reference dummy paging channel burst sequence and every bits of a specific raw burst data of the raw burst data to obtain a matching metric according to a comparing result thereof; and determining the raw burst data is a dummy paging channel message if the matching metric is greater than a dummy paging channel threshold value.

### BACKGROUND OF THE INVENTION

1. Field of Invention

The present invention relates in general to a paging channel in cellular wireless communication systems, and more particularly to a method and system for dummy paging channel message detection.

2. Related Art

In a conventional cellular wireless communication system, an idle mode is provided by the system to achieve the reduction of the power consumption. Taking GSM for example, in idle mode, the mobile station (MS) has to listen to the Paging Channel (PCH). When a telephonic call is coming, the cellular base-station pages the mobile station through the paging channel.

The Paging Channel (PCH) is a downlink channel used by the network to notify the mobile station (MS) of incoming calls. It is transmitted on every control multi-frames (51 frames) by the network. With Discontinuous Reception (DRX) feature, the MS do not need to listen to the PCH on every control multi-frames. But the MS still need to listen to the PCH on every 2 to 9 control multi-frames depending on the network settings. The frame which the mobile has to monitor for the PCH is then determined by the MS paging group, itself calculated with the temporary mobile identity (TMSI) granted by the network. The MS have to listen to all the PCH messages within their own paging group whether there is a paging indication or not, and whether the indication is intended for the designated MS or for another one.

According to 3GPP TS 05.08, it can be read that “On the PCH the network shall send valid layer 3 messages according to 3GPP TS 04.18. Unused signaling blocks on the CCCH/BCCH (Common Control Channel/Broadcast Control Channel) shall contain L2 fill frames. Other unused timeslots shall transmit dummy bursts.” In other words, a valid paging request (with a valid header and valid fields) has to be sent at any time, even when no mobile needs to be paged and no PCH control information needs to be sent. A valid paging channel message not containing any paging information for any MS and any paging control information is called a “dummy PCH message”. However, in an idle mode for mobile station, when the dummy paging channel message is received either a normal paging channel message is received, mobile station has to perform a decoding procedure to the received paging channel message. Therefore, the paging channel (PCH) is responsible for a non-negligible part of the energy dissipation of GSM modem chips because it has to be listened to by the mobile station (MS) at all time.

### SUMMARY OF THE INVENTION

It is therefore a first objective of the present invention to provide a method for detecting dummy paging channel message to reduce the data process in a power saving mode by a mobile station and to increase the battery life of the mobile station.

It is therefore a second objective of the present invention to provide a system for detecting dummy paging channel message to reduce the power consumption and bandwidth waste in a power saving mode by a mobile station.

In order to achieve the abovementioned first object of the present invention and other object of the present invention, a method for detecting dummy paging channel message, adapted for a mobile station is provided, wherein the method comprises the steps of: providing a reference dummy paging channel burst sequence; when a plurality of raw burst data is received, the method comprising: comparing every bits of the reference dummy paging channel burst sequence and every bits of a specific raw burst data of the raw burst data to obtain a matching metric according to a comparing result thereof; and determining the raw burst data is a dummy paging channel message if the matching metric is greater than a dummy paging channel threshold value.

In order to achieve the abovementioned second object of the present invention and other object of the present invention, a system for detecting dummy paging channel message, the system comprises a receiving unit, a sequence providing unit, a determination unit and a decoding unit. The receiving unit is used for receiving a plurality of raw burst data. The sequence providing unit is used for providing a reference dummy paging channel burst sequence. The determination unit is respectively coupled to the receiving unit and the sequence providing unit, for comparing every bits of the reference dummy paging channel burst sequence with every bits of a specific raw burst data of the raw burst data to obtain a matching metric according to a comparing result thereof, and for determining whether the matching metric is greater than a dummy paging channel threshold value, and for outputting a determination signal to the receiving unit, wherein the determination signal is in a first state when the matching metric is greater than the dummy paging channel threshold value, the determination signal is in a second state when the matching metric is smaller than or equal to the dummy paging channel threshold value. The decoding unit is coupled to the receiving unit, for decoding the raw burst data. When the determination signal is in the first state, the receiving unit abandons the raw burst data. When the determination signal is in the second state, the receiving unit sends the raw burst data to the decoding unit.

The present invention takes one of the raw burst data to compare with the sequence generates from the standard dummy paging channel request such that the result thereof is used for determining whether the raw burst data is the dummy PCH message. Thus, the dummy PCH message can be blocked before de-interleaving, decoding and/or error correction and so on. The power consumption and the bandwidth waste of the mobile station can be greatly reduced. Also the battery life of the mobile station can be therefore prolonged.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1(a) illustrates a schematic depicting the data structure of the Layer 2 PCH message according to an embodiment of the present invention.

FIG. 1(b) illustrates a code information table according to an embodiment of the present invention.

FIG. 1(c) illustrates a table depicting codes of the channel MS1 field and the channel MS2 field according to an embodiment of the present invention.

FIG. 1(d) illustrates a table depicting codes of the page mode field according to an embodiment of the present invention.

FIG. 1(e) illustrates a table depicting codes of the field for type of identity according to an embodiment of the present invention.

FIG. 1(f) illustrates a table depicting codes of the O/E field for odd/even indication according to an embodiment of the present invention.

FIG. 2 illustrates a flowchart depicting the encoding procedures of the layer 2 PCH message according to an embodiment of the present invention.

FIG. 3 (a) and FIG. 3 (b) illustrate a diagram depicting a form of block rectangular interleaving according to an embodiment of the present invention.

FIG. 4 illustrates a flowchart depicting a method for detecting a dummy PCH message according to the first embodiment of the present invention.

FIG. 5 illustrates a flowchart depicting a method for detecting a dummy PCH message according to the second embodiment of the present invention.

FIG. 6 a schematic depicting bit mapping of 2 patterns of the dummy PCH message according to an embodiment of the present invention.

FIG. 7(a), FIG. 7(b), FIG. 7(c) and FIG. 7(d) illustrate the schematics depicting 4 bit blocks by interleaving the encoded bits of the first type dummy PCH message according to an embodiment of the present invention.

FIG. 8(a), FIG. 8(b), FIG. 8(c) and FIG. 8(d) illustrate the schematics depicting 4 bit blocks by interleaving the encoded bits of the second type dummy PCH message according to an embodiment of the present invention.

FIG. 9 illustrates a table depicting a score of a soft-value with respect to the reference dummy PCH burst sequence according to the second embodiment of the present invention.

FIG. 10(a), FIG. 10(b), FIG. 10(c) and FIG. 10(d) illustrate schematics depicting the simulation when the channel condition is in Additive White Gaussian Noise according to an embodiment of the present invention.

FIG. 11(a), FIG. 11(b), FIG. 11(c) and FIG. 11(d) illustrate schematics depicting the simulation when the channel condition is in TU3 according to an embodiment of the present invention.

FIG. 12(a), FIG. 12(b), FIG. 12(c) and FIG. 12(d) illustrate schematics depicting the simulation when the channel condition is in TU50 according to an embodiment of the present invention.

FIG. 13(a), FIG. 13(b), FIG. 13(c) and FIG. 13(d) illustrate schematics depicting the simulation when the channel condition is in TU100 according to an embodiment of the present invention.

FIG. 14 illustrates a flowchart depicting a method for detecting a dummy PCH message according to the third embodiment of the present invention.

FIG. 15 illustrates a flow chart depicting a method for detecting a dummy paging channel message according to the fourth embodiment of the present invention.

FIG. 16(a), FIG. 16 (b), FIG. 16 (c) and FIG. 16 (d) illustrate schematics depicting the common bit indexes and the residual bit indexes of the bit indexes in bit blocks 1-4 according to an embodiment of the present invention.

FIG. 17 illustrates a flow chart depicting a method for detecting dummy PCH message according to the fifth embodiment of the present invention.

FIG. 18 illustrates a flow chart depicting a method for detecting a dummy PCH message according to the sixth embodiment of the present invention.

FIG. 19 illustrates a schematic depicting typical PCH message repartition over 24 h in Taiwan or in France according to an embodiment of the present invention.

FIG. 20 illustrates a block diagram depicting a system for detecting dummy PCH message according to the seventh embodiment of the present invention.

FIG. 21 illustrates a block diagram depicting a system for detecting dummy PCH message according to the eighth embodiment of the present invention.

FIG. 22 illustrates a block diagram depicting a system for detecting dummy PCH message according to the ninth embodiment of the present invention.

FIG. 23 illustrates a block diagram depicting a system for detecting dummy PCH message according to the tenth embodiment of the present invention.

### DETAILED DESCRIPTION OF THE INVENTION

The present invention will be apparent from the following detailed description, which proceeds with reference to the accompanying drawings, wherein the same references relate to the same elements.

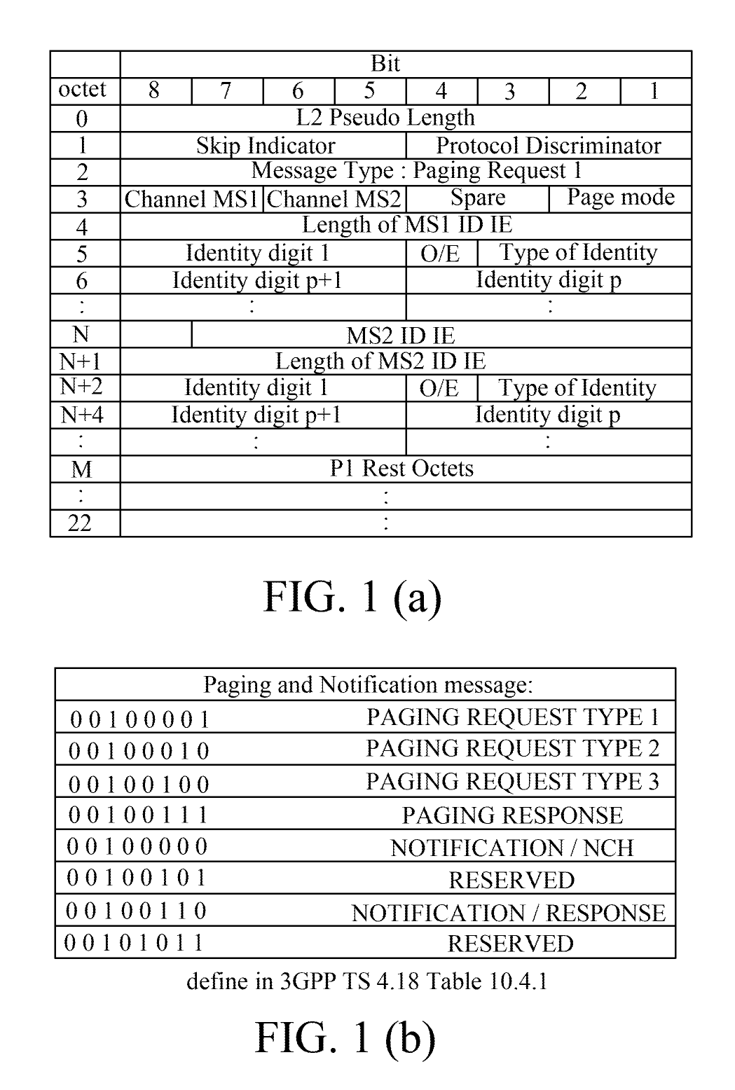

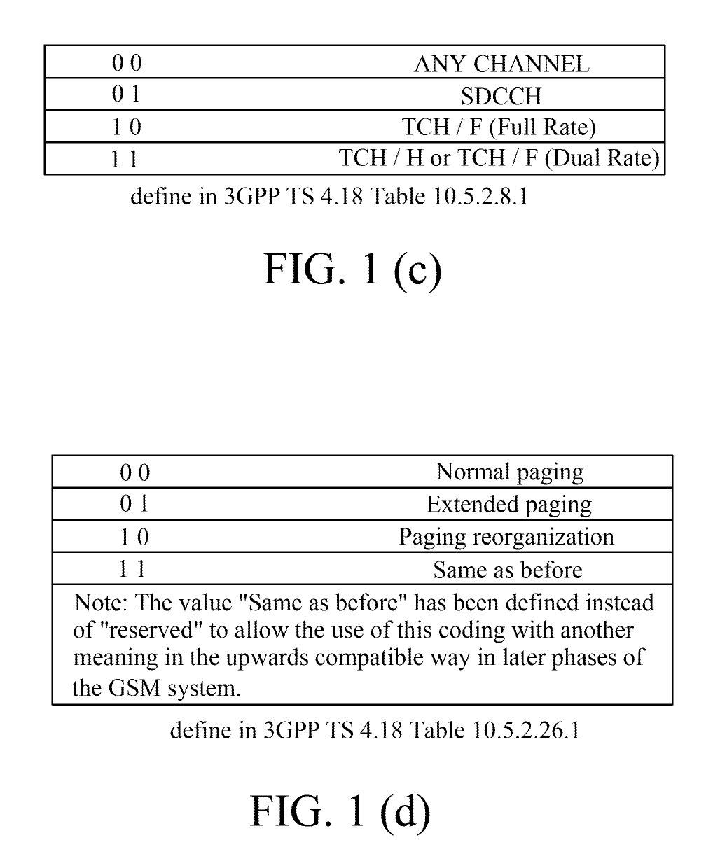

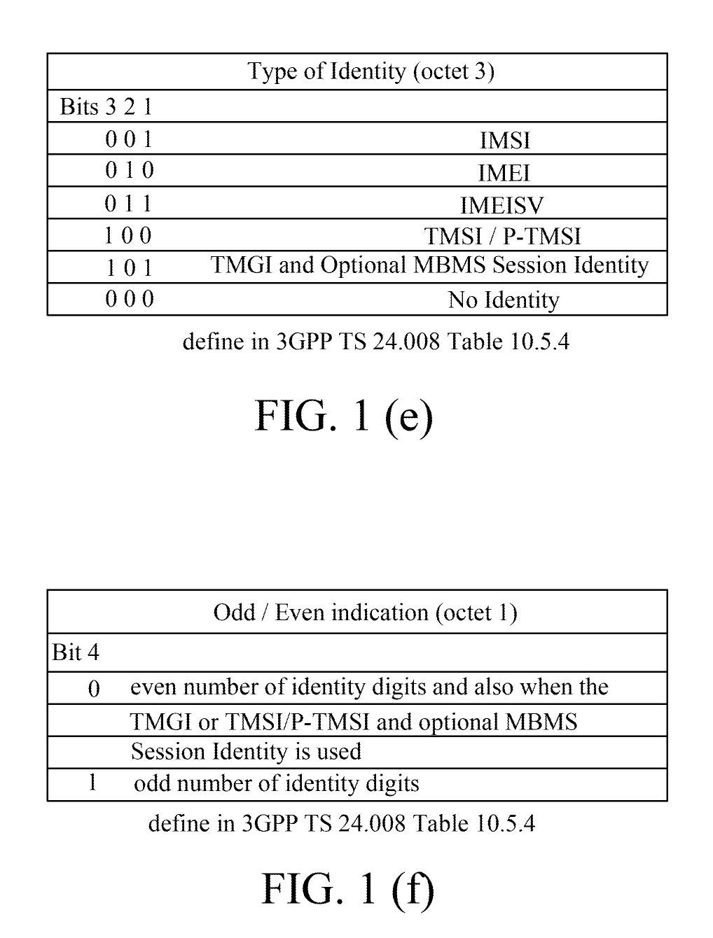

In order to reduce the power consumption of the receiver in the idle mode, the present invention provides a method for dummy paging channel detection. In addition, in order to conveniently describe the present invention, the embodiment takes the GSM system for example, and a receiver is used for listening to the Paging Channel (PCH), wherein the receiver is a mobile station (MS) for example. According to GSM standard, there are three different paging request types of Layer 2 (L2) PCH message structures to accommodate for traffic load variations, wherein the type 1 paging request (PR1) can carry the paging information for up to 2 distinct MS, the type 2 paging request (PR2) can carry the paging information for up to 3 distinct MS, and the type 3 paging request (PR3) can carry the paging information for up to 4 distinct MS. Taking the type 1 paging request (PR1) for example, the L2 PCH message consists of 23 octets, and the data structure with different information fields shows in FIG. 1(a).

FIG. 1(a) illustrates a schematic depicting the data structure of the L2 PCH message according to an embodiment of the present invention. In the schematic of the data structure, octet [0] is a L2 Pseudo length, it is number of bytes in the L2 PCH message excluding the L2 pseudo length fields itself. It is coded on 6 bits in the Least Significant Bits (LSBs), wherein the bit 2 to the bit 1 is always coded as (01)₂. The octet [1] is a skip indicator and a protocol discriminator. If the skip indicator is not coded as (0000)₂, the L2 PCH message can be skipped. The protocol discriminator messages are part of Radio Resources (RR) management protocol and identified by the code (0110)₂=(6)₁₀. The octet [2] indicates a message type field, it is coded on 1 byte. The paging requests of type 1, 2, or 3 are coded on 1 byte according to the table showing in FIG. 1(b) (from 3GPP spec). FIG. 1(b) illustrates a code information table according to an embodiment of the present invention. In the present embodiment, the type 1 paging request (PR1) is taken for example, such that the octet [2] is coded as (00100001)₂. The octet [3] comprises a channel MS1 field, a channel MS2 field, a spare field and a page mode field. The channel MS1 field and the channel MS2 field comprise 2 bits which are coded by the table showing in FIG. 1(c). The spare field comprises 2 bits which are coded to (00)₂. The page mode field comprises 2 bits which are coded according to the table showing in FIG. 1(d).

The octet [4] is a length field which indicates the length of MS1 identity information element (ID IE). The length field is number of bytes of the identity IE excluding the length field itself. The octet [5] comprises a field for identity digit 1, an O/E field for odd/even indication and a field for type of identity. The field for type of identity is coded by the table showing in FIG. 1(e). The O/E field for odd/even indication is coded by the table showing in FIG. 1(f). The octets [6˜N] are a plurality of fields for identity digit. The octet [N] is a field for MS2 identity information element identifier (ID IEI). Since the paging request of type 1 can carry a second mobile identity, the second mobile identity is delimited by the field which is always coded as (17)₁₆. The octet [N+1] is a length field which indicates the length of MS2 identity information element (ID IE). The octet [N+2] comprises a field for identity digit 1, an O/E field for odd/even indication and a field for type of identity. The octets [(N+3)˜(M−1)] are a plurality of fields for identity digit. The octets [M˜22] are a plurality of fields for P1 rest octets. The fields for P1 rest octets can be used to transfer other types of information such as notification list number, packet page indication, and multimedia broadcast multicast service (MBMS) notifications. All unused octets are filled with a fixed pattern: (2B)₁₆.

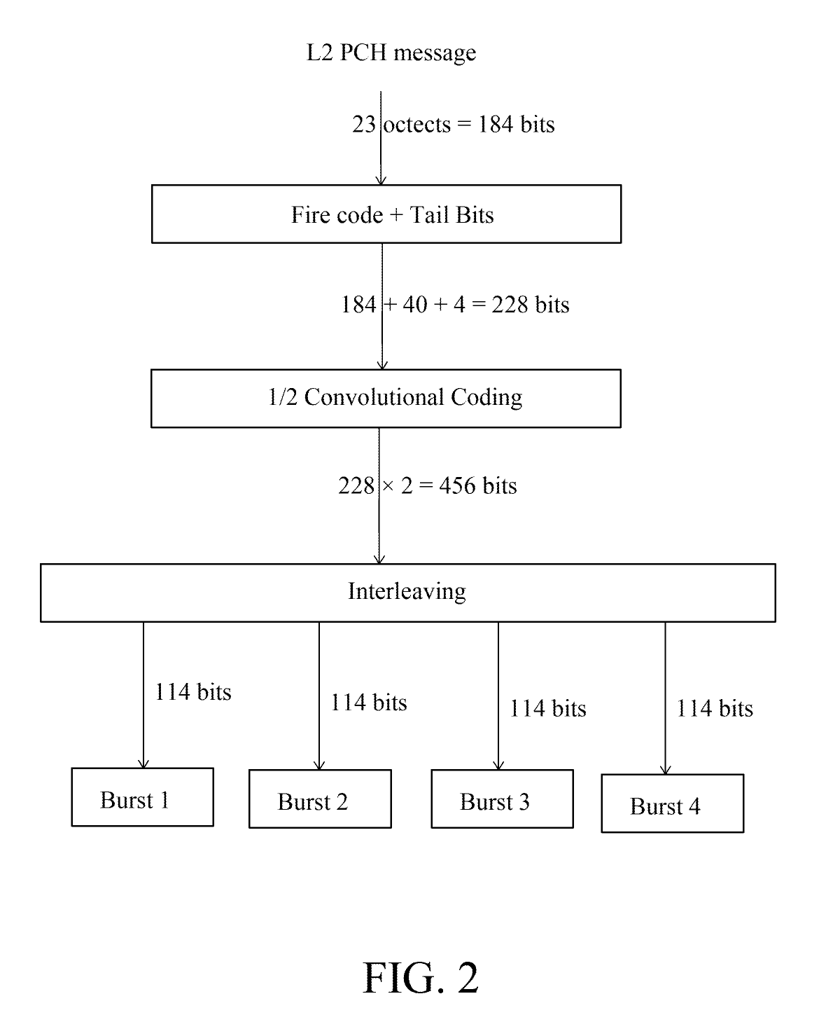

In accordance with the GSM standard, before the layer 2 PCH message transmits, a plurality of encoding procedures are performed, as shown in FIG. 2, such that four consecutive blocks are generated. FIG. 2 illustrates a flowchart depicting the encoding procedures of the layer 2 PCH message according to an embodiment of the present invention. Please referring to FIG. 2, the first two steps involve in applying channel coding to the layer 2 PCH message which comprising 184 bits. The first channel coding uses the Fire code which is a form of CRC (Cyclic Redundancy Check) and is dedicated to use the following polynomial:

g(D)=(D²³+1)·(D¹⁷+D³+1) (1)

The fire code increases the redundancy of the 184 bit message by extra 40 bits. The original 184 bits and extra 40 bits will plus 4 tail bits with the total of 228 bits.

The following channel coding is the convolution coding which is only used for correction purposes. The rate of the convolution encoder is ½, for 1 input bit and 2 output bits are produced. The following 2 polynomials are used:

G0=1+D3+D4

G1=1+D+D3+D4 (2)

This form of convolution coding is extremely efficient but also doubles the size of the message from 228 bits to 456 bits.

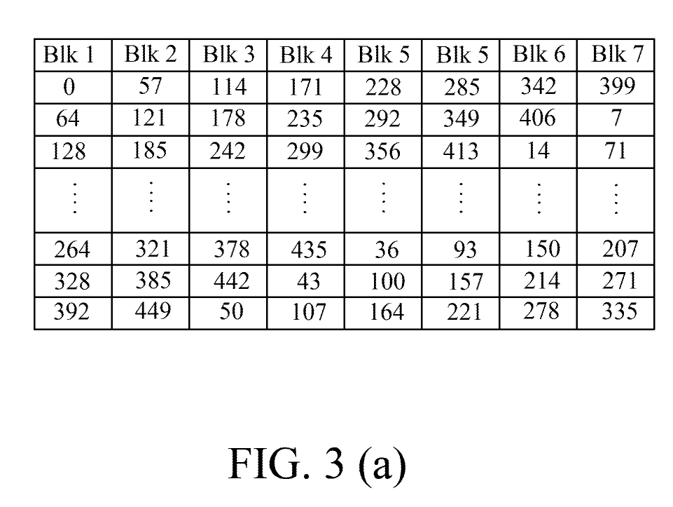

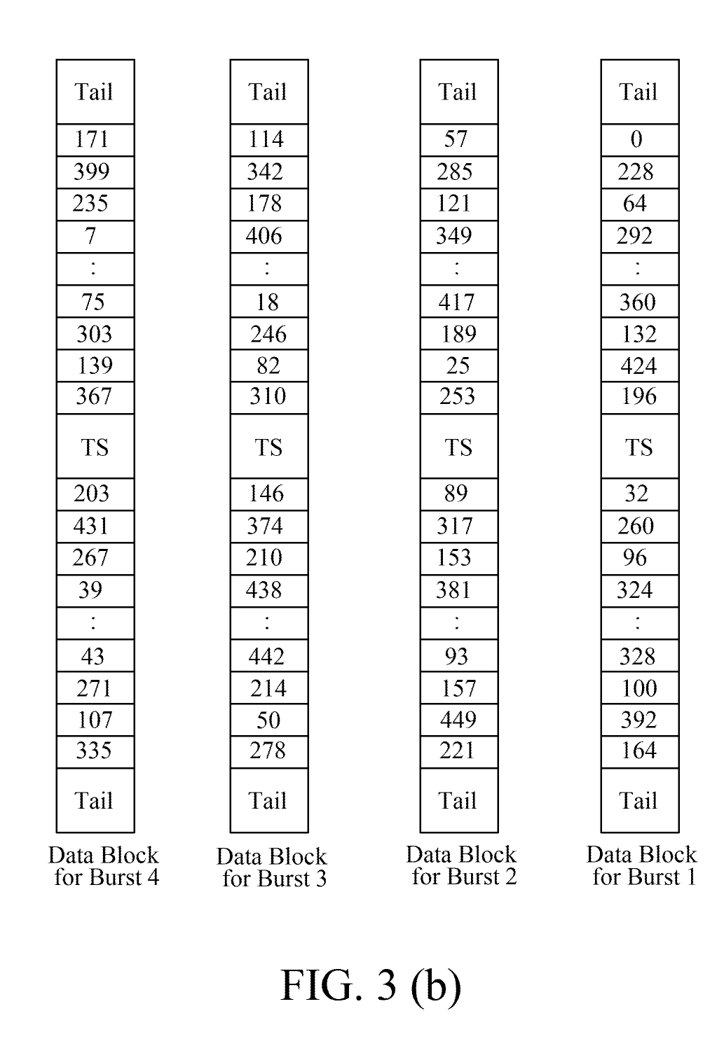

These 456 bits are then interleaved such that the bits are shuffled around in a predetermined way and are then divided into a succession of 4 bursts, each containing 114 bits. This form of interleaving is a technology of block rectangular interleaving and is shown diagrammatically in FIG. 3(a) and FIG. 3(b). Usually transmission errors occur as error bursts, therefore the object of the interleaving process is to spread the errors evenly over the transmitted data, allowing the channel decoding in the receive sequence to achieve error correction more efficiently.

### First Embodiment

According to 3GPP TS 05.08, a valid paging request (with a valid header and valid fields) has to be sent at any time, even when no mobile needs to be paged and no PCH control information needs to be sent. A valid paging request not containing any paging information for any MS and any paging control information is called a “dummy PCH message”. Therefore, in the embodiment of the present invention, a method for dummy paging channel message detection is provided such that a quantity of data process and the power consumption of the receiver can be reduced.

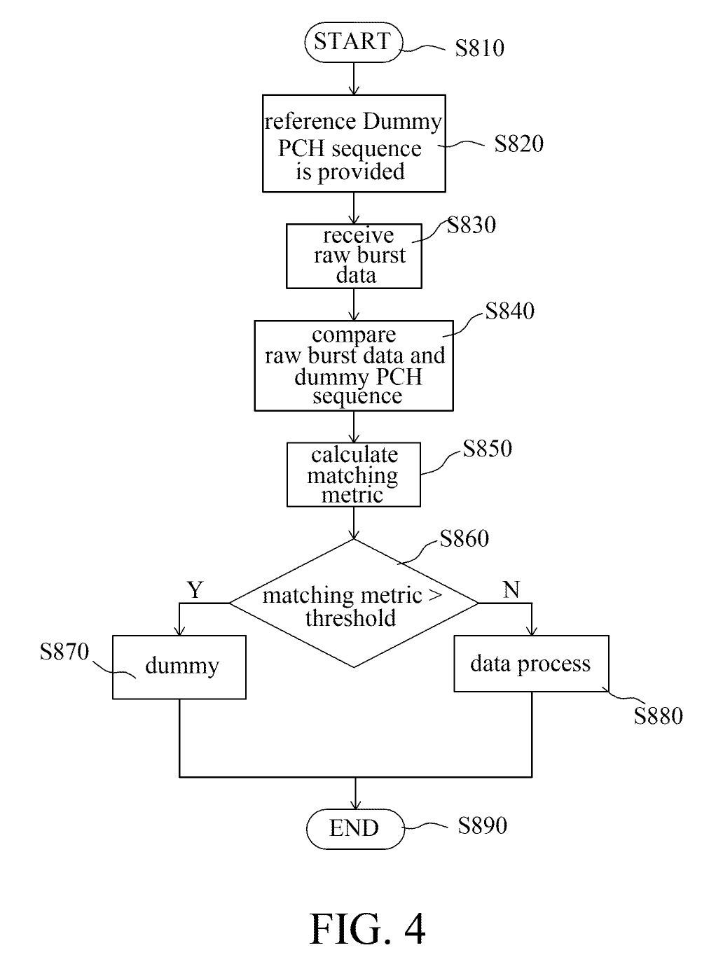

FIG. 4 illustrates a flowchart depicting a method for detecting a dummy PCH message according to the first embodiment of the present invention. Please referring to FIG. 4, the method includes the steps of:

In step S810, the method for dummy PCH message detection starts.

In step S820, a reference dummy PCH burst sequence is provided. Since the GSM standard already has the requirement about the information form of each field of PCH message, some fixed patterns of the dummy PCH message can be derived according to the GSM standard. Also, some fixed type bursts will be generated when the fixed patterns of the dummy PCH message are encoded by the encoding procedures in FIG. 2. The reference dummy PCH burst sequence is in advance generated based on the fixed patterns of the dummy PCH message according to an embodiment of the present invention.

In step S830, the raw burst data is received. In the present embodiment, since the received paging request of each receiver at least includes 4 bursts, in this step, at least 4 raw burst data is received. Each raw bit of the raw burst data in GSM system is represented in a fixed range, such as a number between −7 and 7. When the number the received raw bit of the raw burst data is close to “7”, such as “6”, the probability of logic 1 of the raw bit would be higher than the probability of logic 0. When the number the received raw bit of the raw burst data is close to “−7”, such as “−6”, the probability of logic 0 of the raw bit would be higher than the probability of logic 1. When the number the received raw bit of the raw burst data is “0”, the probability of logic 0 of the raw bit would be equal to the probability of logic 1. When the number the received raw bit of the raw burst data is close to “0”, the uncertainty of logic of the raw bit would be increased.

In step S840, each bit of a specific raw burst data of the raw burst data is adopted to be compared with each bit of the reference dummy PCH burst sequence. In the present embodiment, the receiver can select at least one of the raw burst data to be the specific raw burst data for performing the comparison. The specific raw burst data can be set in advance by engineers or can be adaptively selected by receiver according to the channel status and/or other parameters.

The method for comparison is to take each raw bit of the specific raw burst data to compare with each bit of the reference dummy PCH burst sequence. Since the raw bit of the raw burst data is represented as the number between “−7” and “7”, a scoring method can be created so that the score thereof (also called the matching metric) can be used to represent the comparison result between the specific raw burst data and the reference dummy PCH burst sequence. After that, the step S860 can used the score (the matching metric) for determination. The abovementioned scoring method will be described in the following second embodiment.

In the step S850, a matching metric is calculated in accordance with the abovementioned comparison result. The difference between the each bit of the specific raw burst data and each bit of the reference dummy PCH burst sequence can be obtained in accordance with the comparison result, and the difference thereof is represented as the matching metric.

In step S860, it is determined whether the abovementioned matching metric is greater than a dummy PCH threshold value or not. When the matching metric is greater than the dummy PCH threshold value, the step S870 is performed. When the matching metric is smaller than or equal to the dummy PCH threshold value, the step S880 is performed. The dummy PCH threshold value can be pre-designed by designer or can be adaptively adjust by receiver according to the channel status and/or other parameters.

In step S870, when the matching metric is greater than the dummy PCH threshold value, it is determined that a PCH message carried by the raw burst data is the dummy PCH message and the raw burst data will be abandoned. When the receiver determines that the paging request carried by the raw burst data is the dummy PCH message, the receiver ignores the raw burst data instead of performing de-interleaving, decoding and error correction, etc. . . . . Therefore, the amount of the data process of the receiver can be reduced, and also the bandwidth waste and the power consumption can be reduced.

In step S880, when the matching metric is smaller than or equal to the dummy PCH threshold value, a conventional data process, such as de-interleaving, decoding, error correction, etc, is performed. In this step, the receiver would obtain the normal paging channel message to obtain the paging information thereof, and the corresponding process thereof would be performed according to the paging information, such as the changing idle mode to the active mode. However, if the step is performed, the decoded paging channel message still is a dummy PCH message; the receiver would also ignore the dummy paging channel message according to a standard procedure.

In the step S890, the method for dummy PCH message detection ends.

According to the description of the steps S860, S870 and S880, when the matching metric is greater than the dummy PCH threshold value, it represent the raw burst data carrying the dummy PCH message, the raw burst data could be ignored to reduce the amount of data process of the mobile station and the power consumption thereof. When the raw burst data carries the dummy paging channel message and the steps S860 does not identify it since the matching metric is smaller than or equal to the dummy PCH threshold value, the dummy PCH message also would be decoded in the step S880. Therefore, the PCH message carried by the raw burst data will be processed in proper whether the PCH message is dummy PCH message or not, and false detection of dummy paging channel message would not occur.

### The second embodiment

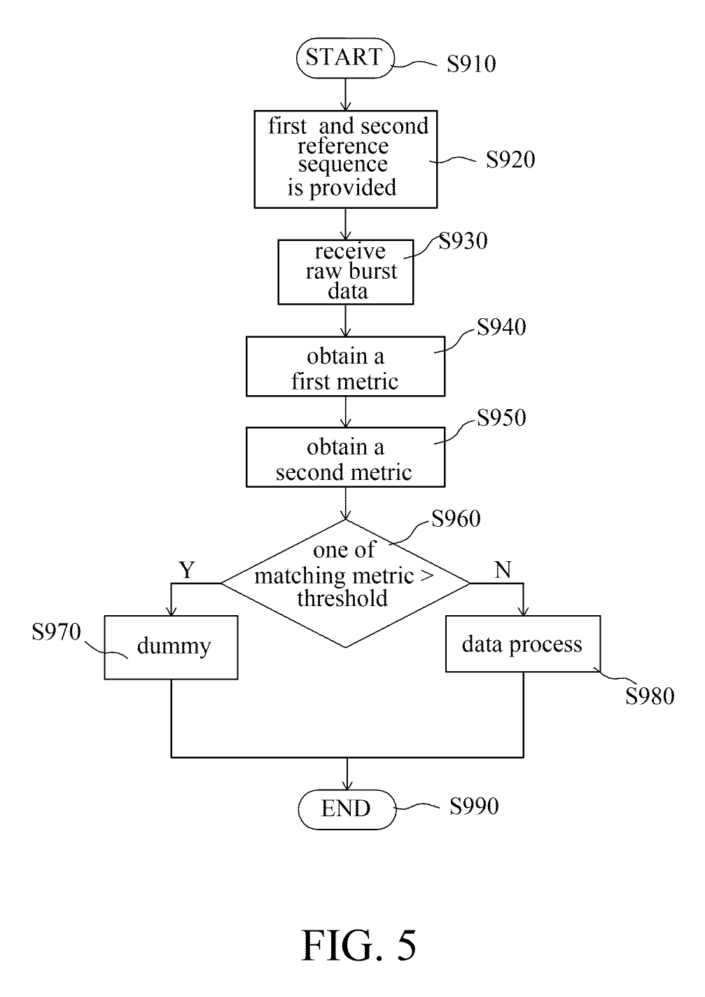

For conveniently describing the second embodiment of the present invention, the GSM system is also taken for example, and a receiver is used for listening to the Paging Channel (PCH), wherein the receiver is a mobile station (MS) for example. FIG. 5 illustrates a flowchart depicting the method for detecting a dummy PCH message according to the second embodiment of the present invention. Please referring to FIG. 5, the method comprises the steps of:

In step S910, the method for detecting the dummy PCH message starts.

In step S920, a reference dummy PCH burst sequence is provided. In the present embodiment, the reference dummy PCH burst sequence includes a first reference sequence and a second reference sequence. Since each field of the PCH message has rules in the GSM standard as shown in FIG. 1(a), as description of FIG. 1(a), the values stored in each fields of the dummy PCH message will be very characteristic and quite distinct from regular paging request. Essentially 2 fixed patterns of dummy PCH message are used when no mobile is paged and no control information is sent, the 2 fixed patterns are called “dummy PCH patterns”. In the present embodiment, the 2 fixed patterns are adopted for generating reference dummy PCH burst sequence. Because the dummy PCH message does not carry any mobile identity and any control information to be used by the mobile station, the dummy PCH patterns have the following characteristics.

1. A dummy PCH message is a valid paging request, so the octet [1]=(00000110)₂.

2. A dummy PCH message is belonged to the type 1 paging request (PR1), so the octet [2]=(00100001)₂ according to FIG. 1(b).

3. The channel fields are set as “any channel”, so the octet [3], bits [8 . . . 5]=(0000)₂ according to FIG. 1(c). The octet [3], bits [4 . . . 3] (Spare field) are always fixed to (00)₂. If the page mode of the received PCH message is different from a normal paging, the MS will decode the PCH message and forward it to upper protocol stack layers. So, the page mode is set to normal, that is, the octet [3], bits [2 . . . 1]=(00)₂.

4. The identity information element (ID IE) does not contain any identity, therefore the length of MS1 ID IE will equal to 1 octet (the octet with the type of identity). The octet [4]=(00000001)₂.

5. The type of identity for MS1 is set to “no identity”, so the octet [5], bits [3 . . . 1]=(000)₂ and the octet [5], bit [4]=(0)₂. Due to the dummy PCH message with no MS ID and according to the GSM standard, the octet [5], bits [8 . . . 5] could be filled with (0000)₂ or (1111)₂.

6. Since the dummy PCH message doesn't carry the paging information for a MS2 and excludes P1 rest octets, these fields are filled with the fill pattern, i.e. the octets [6 . . . 22]=(2b)₁₆=(00101011)₂.

7. As description above, the first 6 octets of the dummy PCH message are filled with information while the rest is filled with the fill pattern. Which means that the L2 pseudo length which exclusive itself will be equal to 5, i.e. octet [0], bits [8 . . . 3]=(00101)₂. The octet [0], bits [2 . . . 1] are always coded as (01)₂.

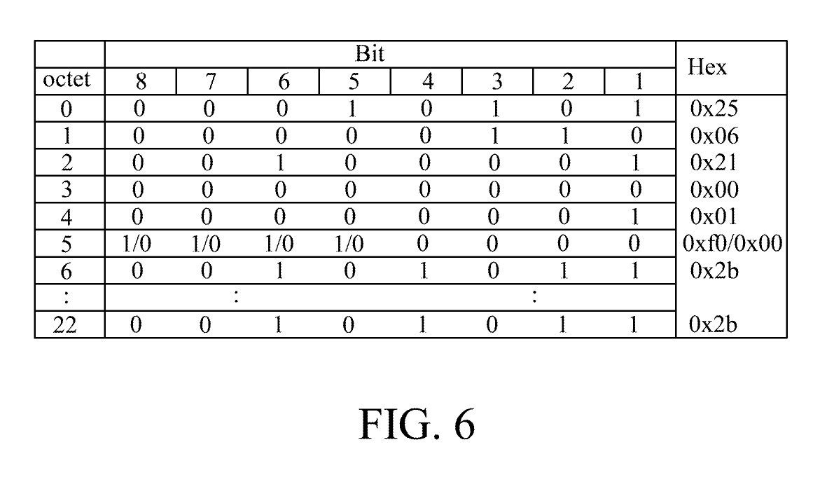

Due to octet [5], bits [8 . . . 5] may be filled with either (0000)₂ or (1111)₂, 2 patterns of the dummy PCH message will be produced and are shown diagrammatically in FIG. 6. FIG. 6 illustrates a schematic depicting bit mapping of 2 patterns of the dummy PCH message according to an embodiment of the present invention. In the rest of the following embodiment document the dummy PCH with octet [5]=(f0)₁₆=(11110000)₂ will be referred to as a first type dummy PCH message and the one with octet [5]=(00)₁₆=(00000000)₂ will be referred to as a second type dummy PCH message.

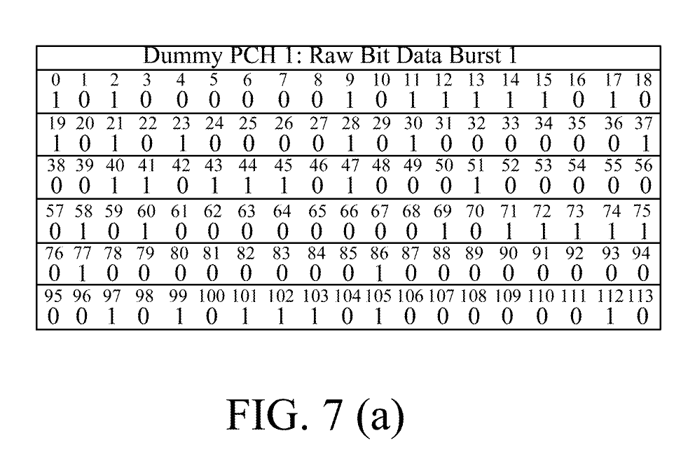

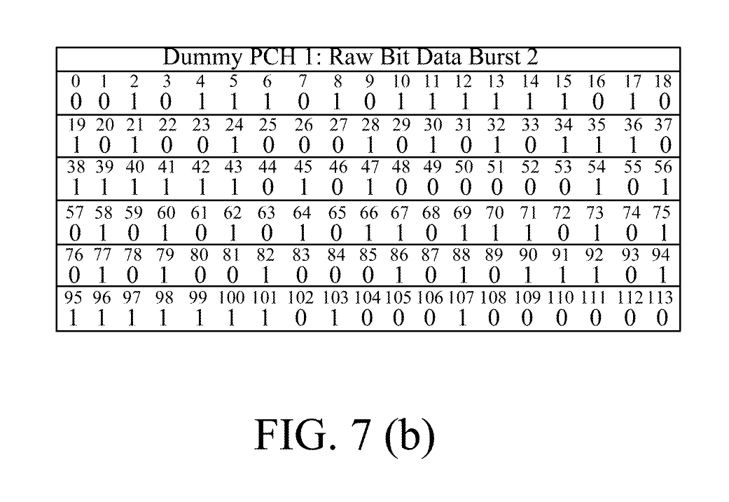

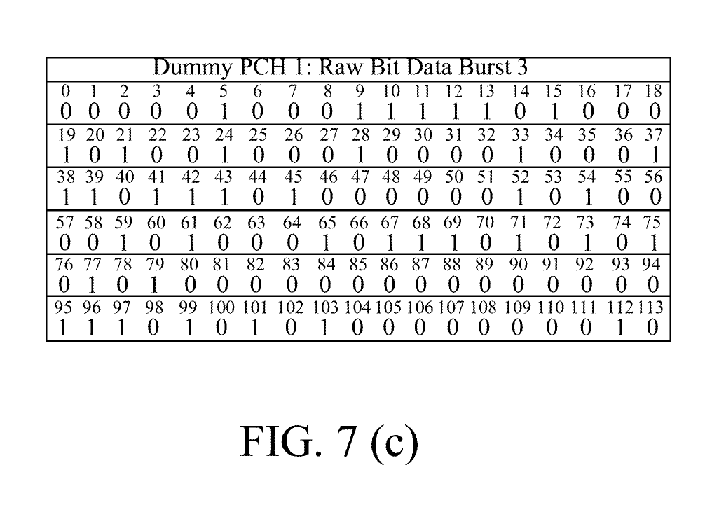

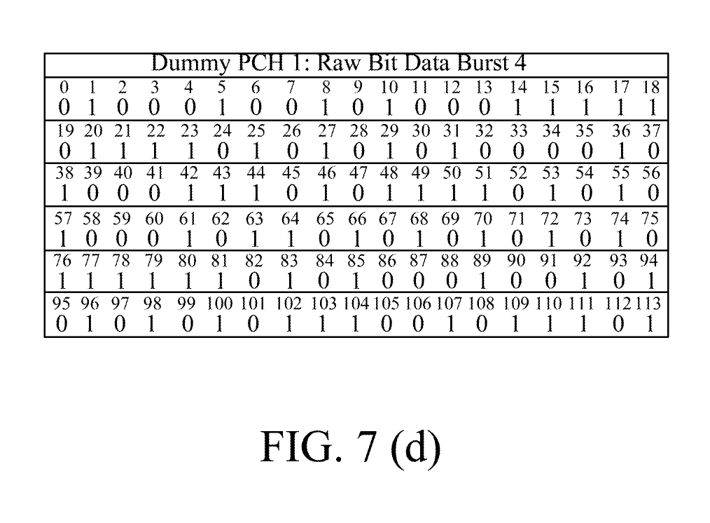

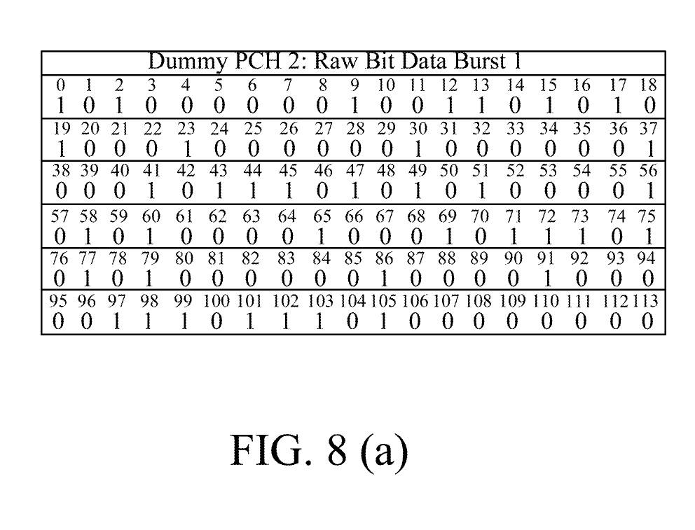

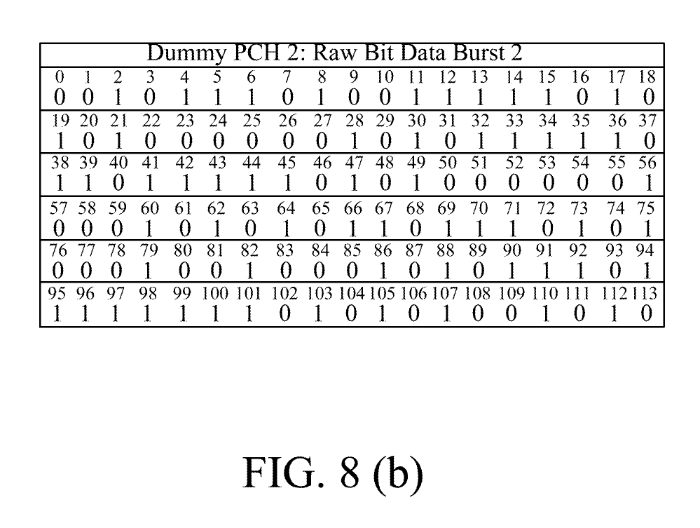

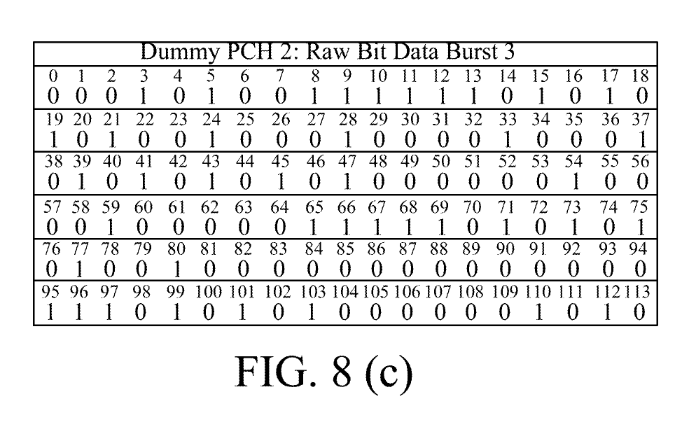

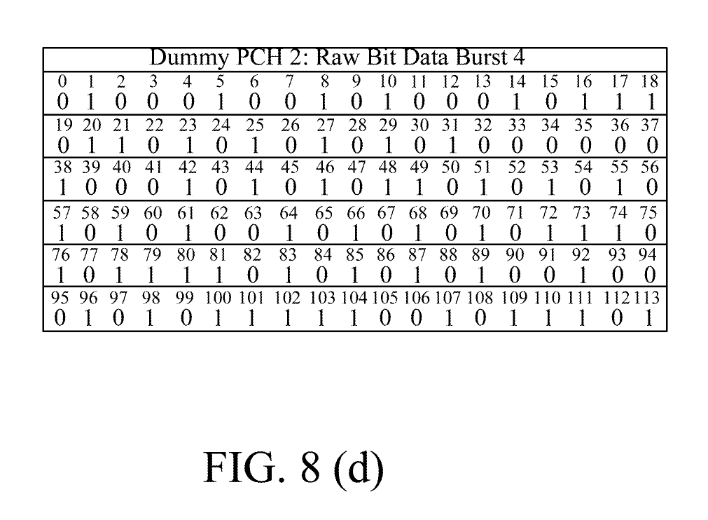

According to the description about FIG. 2, the first type dummy PCH message would be encoded by the fire code and then be encoded by the convolution code to obtain a plurality of encoded bits, and the length thereof is 456 bits. According to FIG. 3, the encoded bits are interleaved and divided into 4 bit blocks (also called bursts). They are individually illustrated in FIG. 7(a), FIG. 7(b), FIG. 7(c) and FIG. 7(d). Similarly, the second type dummy PCH message would be encoded as the above description to obtain 4 bit blocks (bursts). They are individually illustrated in FIG. 8(a), FIG. 8(b), FIG. 8(c) and FIG. 8(d).

In the present embodiment, one of the 4 bit block generated by the abovementioned first type dummy PCH message would be selected as a first reference sequence. Generally speaking, the 1^{st} bit block generated by the first type dummy PCH message corresponds to the 1^{st} raw burst data, the 2^{nd} bit block generated by the first type dummy PCH message corresponds to the 2^{nd} raw burst data, the 3^{rd} bit block generated by the first type dummy PCH message corresponds to the 3^{rd} raw burst data, and the 4^{th} bit block generated by the first type dummy PCH message corresponds to the 4^{th} raw burst data. Therefore, if the 3^{rd} raw burst data is chosen to serve as the specific raw burst data by the receiver, the 3^{rd} bit block generated by the first type dummy PCH message would be selected as the first reference sequence. Similarly, the 1^{st} bit block generated by the second type dummy PCH message corresponds to the 1^{st} raw burst data, the 2^{nd} bit block generated by the second type dummy PCH message corresponds to the 2^{nd} raw burst data, the 3^{rd} bit block generated by the second type dummy PCH message corresponds to the 3^{rd} raw burst data, and the 4^{th} bit block generated by the second type dummy PCH message corresponds to the 4^{th} raw burst data. Therefore, if the 2^{nd} raw burst data is chosen to serve as the specific raw burst data by the receiver, the 2^{nd} bit block generated by the second type dummy PCH message would be selected as the second reference sequence. Moreover, the first reference sequence and the second reference sequence can be stored in the memory of the mobile station or the first reference sequence and the second reference sequence can be adaptively generated according to the channel situation and/or control parameter.

In the step S930, a plurality raw burst data is received. In the specification of the GSM system, a valid PCH message is carried by four consecutive bursts. Thus, the mobile station would receive at least 4 raw burst data, wherein one of the raw burst data would be served as the specific raw burst data. The specific raw burst data would be used for determining whether the multiple raw burst data is the dummy PCH message or not. In the embodiment, the specific raw burst data can be set in advance by engineers or can be adaptively selected by receiver according to the channel status and/or other parameters. Generally, the specific raw burst data has already been equalized or operated by other signal processes, such as sampling and quantization, etc, so that each raw bit of the specific raw burst data is represented in a fixed range, such as a number between −7 and 7.

In step S940, The specific raw burst data is compared with the first reference sequence to calculate a first metric according to the comparison result thereof. In the following embodiment, the calculating method of the first metric would be described. In the present embodiment, there is a corresponding relationship between the first reference sequence and the specific raw burst data. For example, if the bit block 1 of FIG. 7 is selected to serve as the first reference sequence, it represent that the 1^{st} raw burst data of the raw burst data is also selected to serve as the specific raw burst data.

In the step S950, The specific raw burst data is compared with the second reference sequence to calculate a second metric according to the comparison result thereof. In the following embodiment, the calculating method of the second metric would be described. In the present embodiment, there is a corresponding relationship between the second reference sequence and the specific raw burst data. For example, if the bit block 3 of FIG. 8 is selected to serve as the second reference sequence, it represent that the 3^{rd} raw burst data of the raw burst data is also select to serve as the specific raw burst data. Furthermore, in the present embodiment, the mobile station can select one more bursts to calculate their corresponding first metrics and their corresponding second metrics according to the channel situation and/or other parameters and so on.

In the step S960, the greater metric from the first metric and the second metric is served as a matching metric, and it is determined whether the matching metric is greater than the dummy PCH threshold value or not. When the matching metric is greater than the dummy PCH threshold value, the step S970 is performed. When the matching metric is smaller than or equal to the dummy PCH threshold value, the step S980 is performed. The theoretical range of the dummy PCH threshold value would be described in the following specification. In the present embodiment, the dummy PCH threshold value can be used a preset value by designer or can be adaptively adjusted according to the channel situation and/or another parameters and so on.

In the step S970, when the matching metric is greater than the dummy PCH threshold value, it is determined that the raw burst data is the dummy PCH message. In this step, the mobile station in advance determine that the paging request carried by the raw burst data is the dummy PCH message such that the mobile station can ignore the raw burst data before the interleaving, decoding, and the error correction are performed. Therefore, amount of data process of the receiver, bandwidth waste and power consumption thereof is accordingly reduced.

In the step S980, when the matching metric is smaller than or equal to the dummy PCH threshold value, a conventional data process is performed. The data process is included in de-interleaving, decoding, error correction and so on. In this step, a PCH message can be decoded from the raw burst data to obtain the paging information therein so that the corresponding action thereof can be performed according to the paging information, such as changing idle mode to active mode. However, when the decoded PCH message thereof is the dummy PCH message, the mobile station would also ignore the dummy PCH message.

In the step S990, the method for detecting the dummy PCH message ends.

From the description of the steps S960, S970 and S980, when the raw burst data carries the dummy PCH message and the steps S960 does not identify it since the matching metric is smaller than or equal to the dummy PCH threshold value, the dummy PCH message also would be obtained in the step S980 according to the conventional data process. Therefore, the PCH message carried by the raw burst data will be processed in proper whether the PCH message is dummy PCH message or not, and false detection of dummy paging channel message would not occur.

In the abovementioned steps, the proposed algorithm uses a standard pattern matching technique to identify the dummy PCH message. The idea here is to compute a matching metric/score (including the first metric and the second metric) to assess the Hamming distance between the received raw burst data and the reference dummy PCH burst sequence and then decide if the metric/score is big enough to establish that the received raw burst data are dummy or not. Instead of calculating the Hamming distance (the number of bit differences) we can equivalently sum up the number of identical bits.

In a preferred embodiment, the specific raw burst data would be equalized in the step S930. After the equalization, the specific raw burst data is available as soft-values, i.e. indicating a confidence level corresponding to each bit. For conveniently describing the present embodiment, the raw bit of the specific raw burst data is represented as R[k], that is also the received bits of the GSM burst. It is a soft-value because it can have some uncertainty. If its value is greater than 0, it means we think it is a logic “1”, if its value is smaller than 0 we think it is a logic “0”. The closer the value is to 7 (or −7) the more certain we are about the bit value.

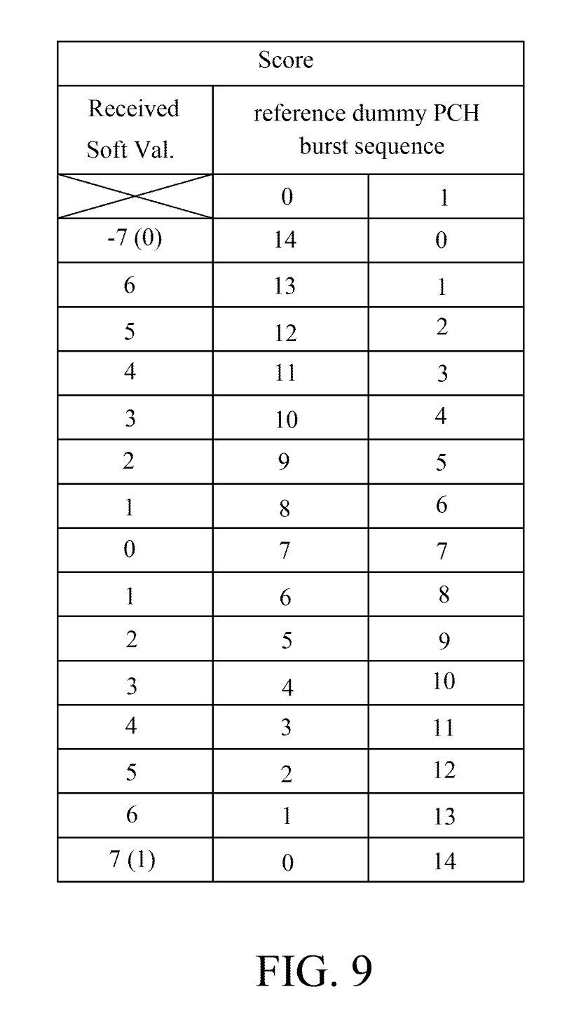

Using those soft-values, the matching metric is computed in the process. A straightforward matching metric computation process will calculate a matching value for each bit as illustrated in the table in FIG. 9. In other words, the raw bit R[k] of the equalized specific raw burst data is a soft-value. Each received soft-value would be used to compare with its corresponding bit of the reference dummy PCH burst sequence to obtain a matching metric. For example, when the quality of reception is perfect, a soft-value of a raw bit is “−7”, and its corresponding bit in the reference dummy PCH burst sequence is logic “0”, it represents a perfect matching, so that the score of the soft-value of the raw bit is “14”. On the contrary, when a soft-value of a raw bit is “−7”, and its corresponding bit in the reference dummy PCH burst sequence is logic “1”, it represents a total dis-matching, so that the score of the soft-value of the raw bit is “0”.

In another aspect, when the quality of reception is perfect, a soft-value of a raw bit is “+7”, and its corresponding bit in the reference dummy PCH burst sequence is logic “1”, it represents a perfect matching, so that the score of the soft-value of the raw bit is “14”. On the contrary, when a soft-value of a raw bit is “+7”, and its corresponding bit in the reference dummy PCH burst sequence is logic “0”, it represents a total dis-matching, so that the score of the soft-value of the raw bit is “0”.

On the analogy of this, all the other scores between 1 and 13 will indicate there is a level of incertitude. Each received soft-value of raw bit would obtain a score according to its corresponding bit of the reference dummy PCH burst sequence. The final score computed for the whole burst payload will then simply be sum of all the scores for the received soft-values to obtain the matching metric. In the step S940, each raw bit of the specific raw burst data would be used to compare with each bit of the first reference sequence to obtain its corresponding score according to the abovementioned description and FIG. 9. The sum of the scores of the raw bits is the first metric. Similarly, in the step S950, each raw bit of the specific raw burst data would be used to compare with each bit of the second reference sequence to obtain its corresponding score according to the abovementioned description and FIG. 9. The sum of the scores of the raw bits is the second metric.

The scoring method described above in cooperation with FIG. 9 can be represented as an equation. The k^{th} raw bit of the specific raw burst data is represented as R[k], wherein R[k] is an integer between A and −A. In the present embodiment, the A is equal to “7”. The length of raw burst data R[k] represent as L, wherein R[k]ε[−7,7], ∀kε[0, L−1]. In addition, the reference dummy PCH burst sequence is represented as S_{ref}[k], wherein S_{ref}[k]ε{0,1}, and the length of the reference dummy PCH burst sequence is L. The reference dummy PCH burst sequence S_{ref}[k] includes a first reference sequence and a second reference sequence, wherein the first reference sequence is represented as S_{ref}_{_{—}}₁[k] and the second reference sequence is represented as S_{ref}_{_{—2}}[k]. the first metric is represented as Score_1, and the calculating method thereof is:

$$Score\_ 1 = {\sum }_{k = 0}^{L - 1} [ 7 + R [ k ] \cdot ( 2 \cdot {S}_{ref \_ 1} [ k ] - 1 ) ] .$$

The second metric is represented as Score_2, and the calculating method thereof is:

$$Score\_ 2 = {\sum }_{k = 0}^{L - 1} [ 7 + R [ k ] \cdot ( 2 \cdot {S}_{ref \_ 2} [ k ] - 1 ) ] .$$

In the present embodiment of the present invention, one of the raw burst data is used to compare with the reference dummy PCH burst sequence in the step S940 and the step S950. Thus, the length L of the S_{ref}[k] and R[k] is 114 bits. In perfect conditions (|R[k]|=7 and 0≦k≦L), a received dummy PCH burst will result in a perfect score: Score_{perfect}_{_{—}}_{match}=114×14=1596.

In the abovementioned multiple steps, a technique to detect a know sequence (reference dummy PCH burst sequence) among others is “pattern matching”. However, for such a technique to be applicable in noisy channels the pattern to be found has to be sufficiently different from all other possible messages. To measure differences in bit sequences an easy metric can be used: the Hamming distance. For our detection scheme, what is particularly interesting in is the bit differences between each dummy PCH patterns and the set of all other possible PCH messages. Further, how many the minimum Hamming distance (Dₘᵢₙ) between one of dummy PCH bursts which are produced by the dummy PCH message and one of bursts which are produced by the any other possible PCH messages.

According to the description about FIGS. 1(a)-(f), at least 3 isolated bit differences between dummy PCH message and other PCH messages. Each of the L2 Pseudo Length field, the length field of MS1 ID IE and the identity field can be easily found an isolated bit difference at least.

The convolution encoder in FIG. 2 for GSM Control CHannel (CCH) produces output sequences on 456 bits that have a minimum Hamming distance between themselves (also called “free” distance) D_{free}=7. I.e. all codes generated have at least 7 different bits from each other. Or, different interpretation: 1 isolated bit difference in 2 input sequences of the convolution encoder in FIG. 2 results in 7 bit differences in its corresponding outputs.

After interleaving the bit differences will get spread almost evenly over the 4 bursts. So, 1 isolated bit difference in the convolution encoder input will produce at least 1 bit difference on any of the 4 bursts.

At least 3 isolated bit differences between dummy PCH message and other PCH messages. And the 3 isolated bit differences which are indirectly inputted to the convolution encoder will result in at least 3 bit differences between one of the 4 dummy bursts produced by the dummy PCH message and corresponding one of 4 bursts which are produced by the any other possible PCH messages. Consequently, applying what we found earlier, we can deduce that Dₘᵢₙ≧3.

Now, there is one more element to consider: the fire code. It is basically a CRC (cyclic redundancy check) code used to detect error burst. The CRC code is appended to the original sequence to form a codeword. For each input message, the fire code is almost unique. However, if two input messages have the same the fire code, the two input messages must quite different. So, following consideration of the convolution code and interleaving, we can safely assume that Dₘᵢₙ≧4 when more considering the fire code.

According to the abovementioned estimation of the minimum Hamming distance (Dₘᵢₙ), the minimum Hamming distance (Dₘᵢₙ) between one of the dummy bursts produced by the dummy PCH message and one of the bursts which are produced by the other possible PCH messages is at least greater than or equal to 4. In this analysis we didn't consider cases of the PCH messages not containing any MS ID but indicating a paging mode different from normal, i.e. dummy PCH structure+the paging mode set to either (01)₂, (10)₂, or (11)₂. These cases are very easy to examine because the resulting bursts for those can be derived and compared to the dummy PCH bursts. It can actually be shown that the Hamming distance for any one of the resulting bursts with the corresponding one of the dummy PCH bursts is always greater than or equal to 12. When the original L2 PCH messages only differ by 1 bit, the origin of this relatively high number of differences between the resulting bursts and the dummy PCH bursts is the redundancy codeword of the fire code. Therefore, it can be still concluded that if the other non-dummy PCH message is highly similar to the dummy PCH message, the minimum Hamming distance (Dₘᵢₙ) is hardly less than 4.

In the following description, it states how to set up the dummy PCH threshold value in the step S960. By the foregoing description, the Hamming distance Dₘᵢₙ between the dummy PCH burst and the burst generated by other possible non-dummy PCH messages is at least greater than or equal to 4. Thus, referring to score table in FIG. 9, the score between the dummy PCH burst and the burst generated by other possible non-dummy PCH messages is at least 4×14 when the perfect reception occurs. The perfect score Score_{petfect}_{_{—}}_{match} of the dummy PCH burst is equal to 1596. Thus, the score of the burst generated by any other possible non-dummy PCH message is at least smaller than or equal to 1596−4×14=1540. In other words, the threshold value can be set between 1596 and 1540 according to the scoring method of the present embodiment of the present invention. If we consider that all PCH messages are equally likely, we just need to apply a maximum likelihood (ML) criterion, i.e. the dummy PCH threshold value T should be set to:

T=Score_{perfect}_{_{—}}_{match}−(Dₘᵢₙ×14)/2

T=1560−(4×14)/2

T=1568

According to the steps describing above, the raw burst data would be determined to serve as the dummy PCH message and be ignored by the mobile station when the score thereof is greater than the dummy PCH threshold value. However, two kind of error detection would occur in noisy channel. The first error is the miss-detection. The miss-detection means that the determination is not a dummy PCH message in the steps S960-S980, however, the carried PCH message of the raw burst data is the dummy PCH message. The second error is the false-detection. The false-detection means that the determination is a dummy PCH message in the steps S960-S980, however, the carried PCH message of the raw burst data is a normal (non-dummy) PCH message. However, the case of miss-detection is more acceptable than the case of the false-detection. Indeed, the miss-detection will be followed by the normal decode process which should decode the dummy PCH message correctly, whereas the false-detection will prevent the mobile station from decoding of a valid paging channel message. If the valid paging channel message was addressed to the mobile station, the mobile station will lead to missing a call.

In other words, the higher the dummy PCH threshold value is, the higher the probability of the miss detection is. The lower the dummy paging channel threshold value is, the higher the probability of the false-detection is. So being conservative in this case (i.e. keeping a relatively high threshold) protects us more against the false-detection.

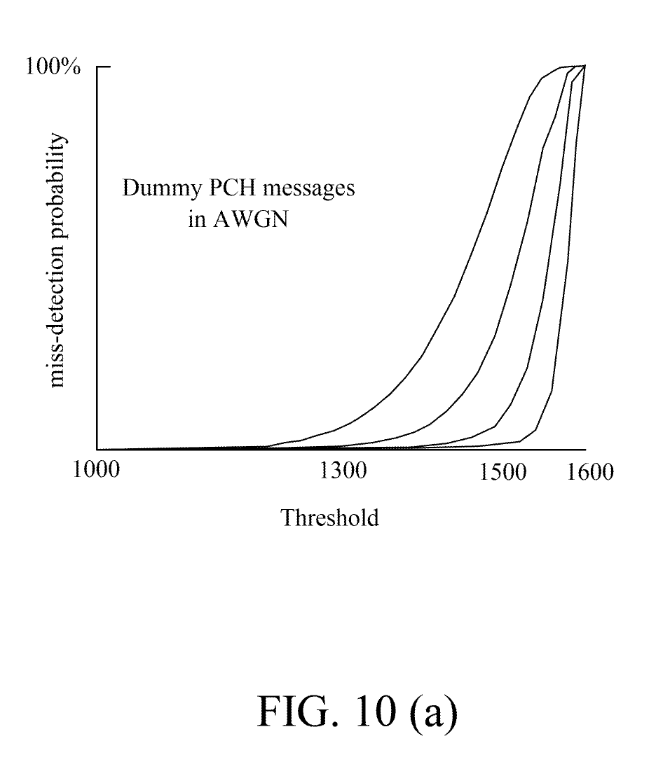

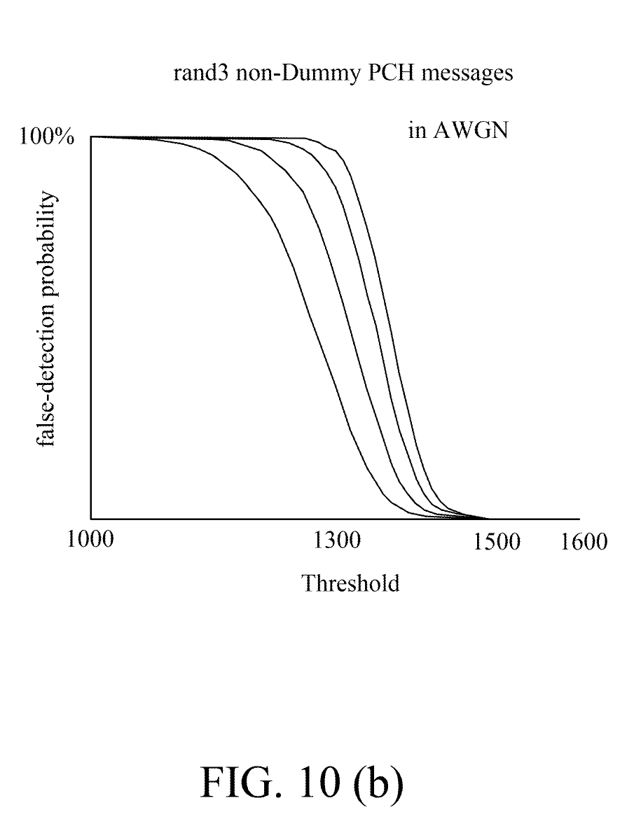

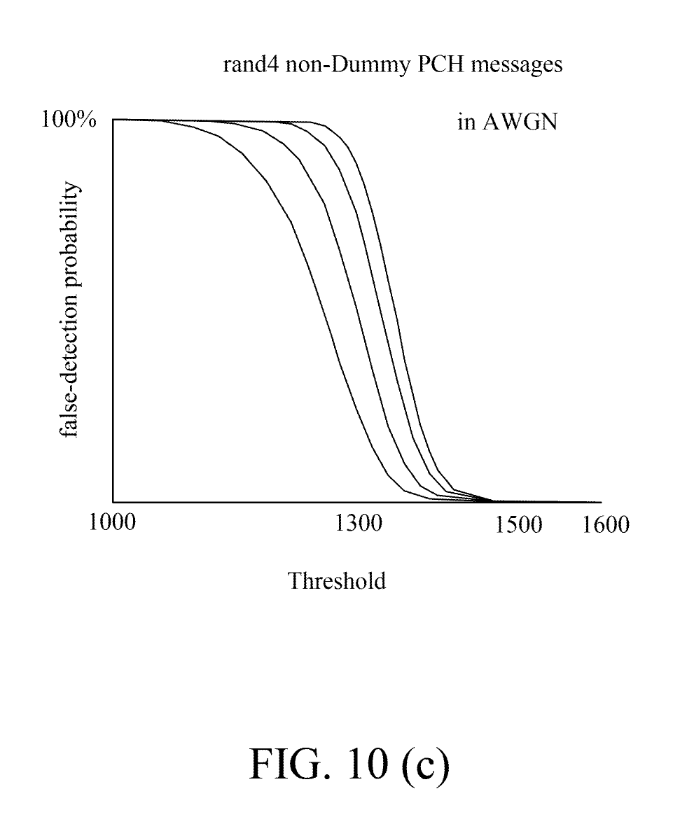

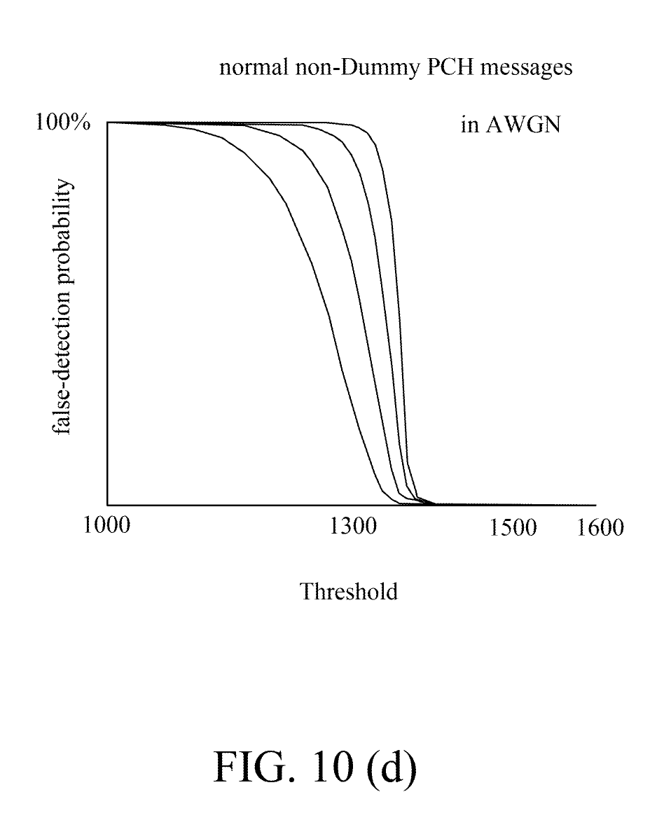

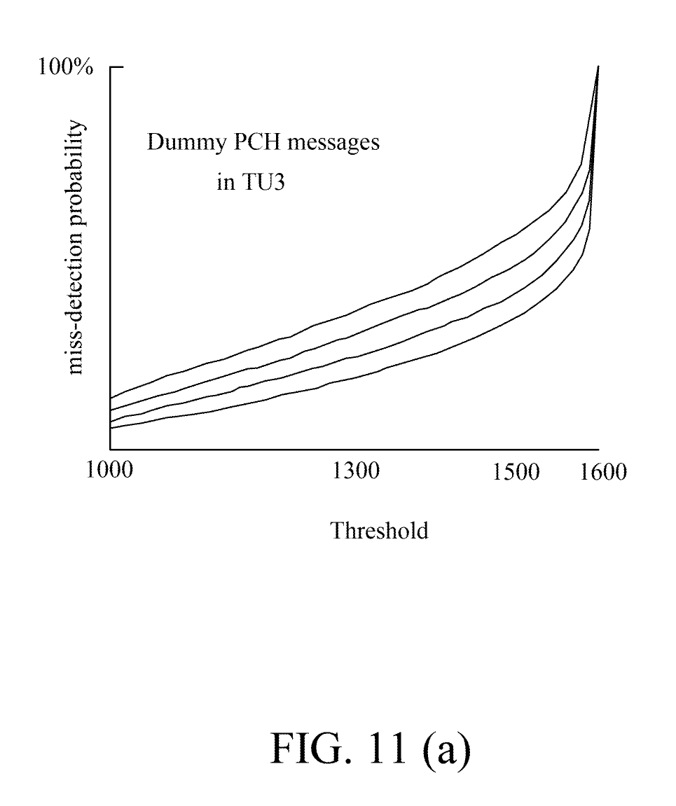

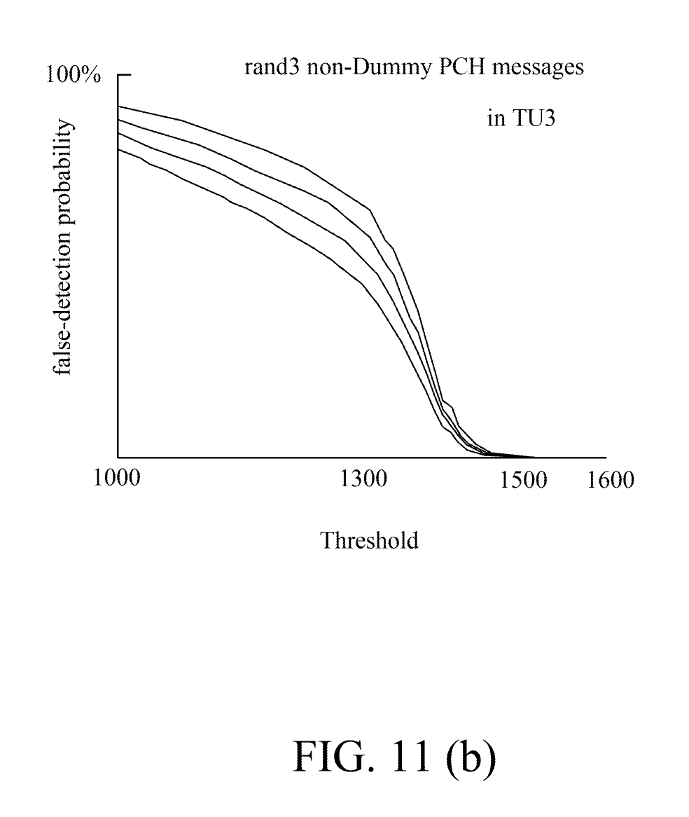

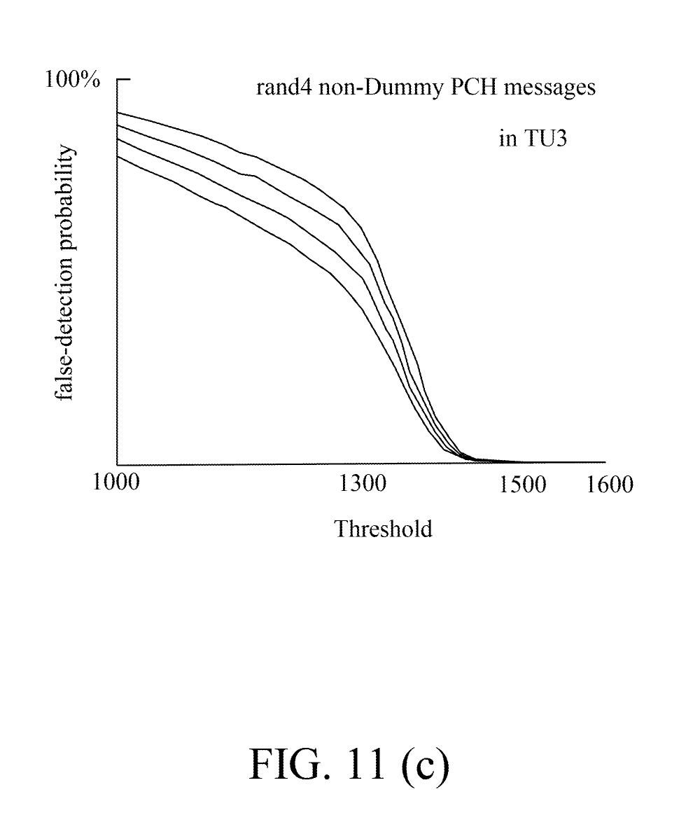

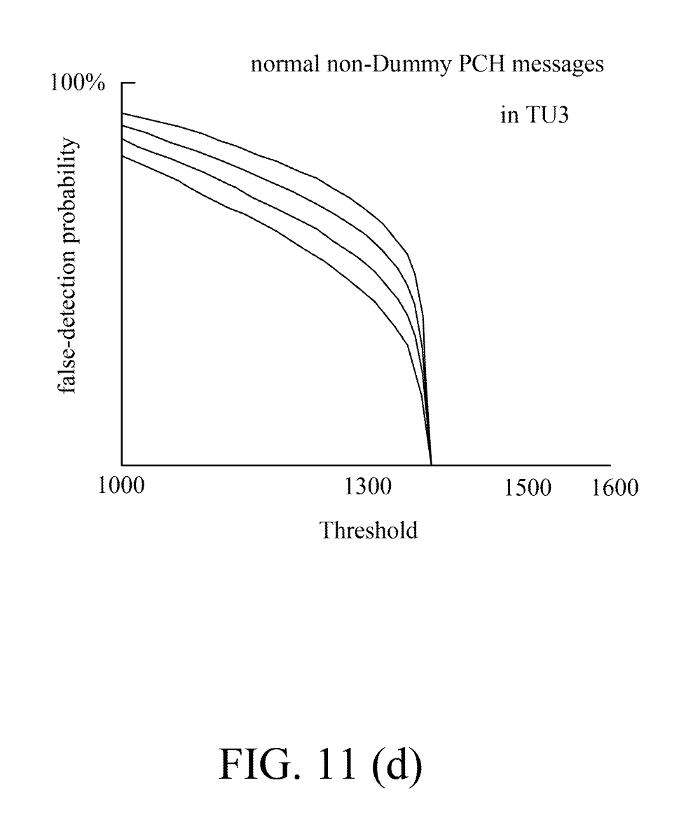

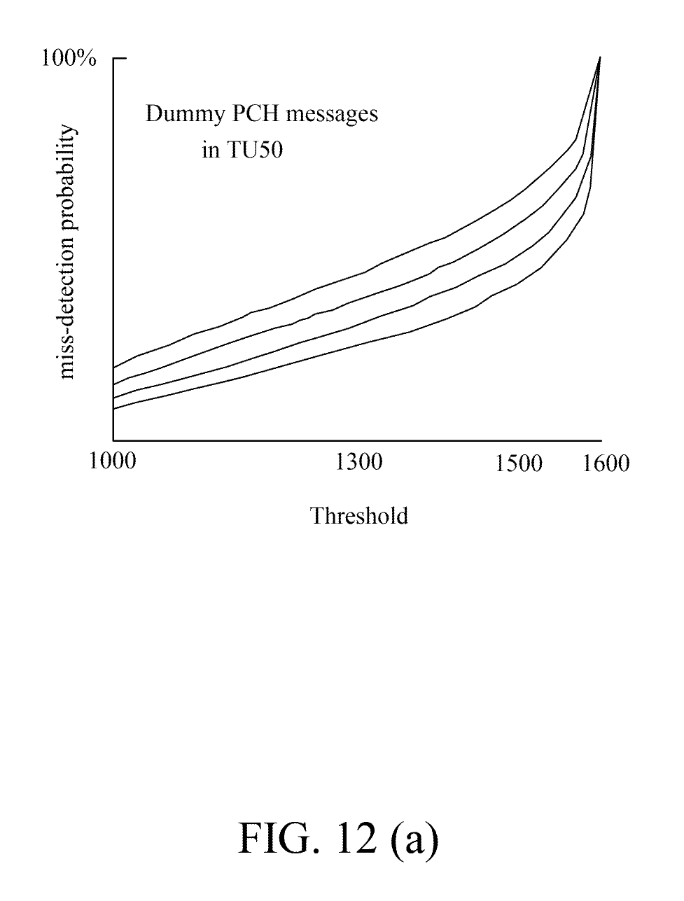

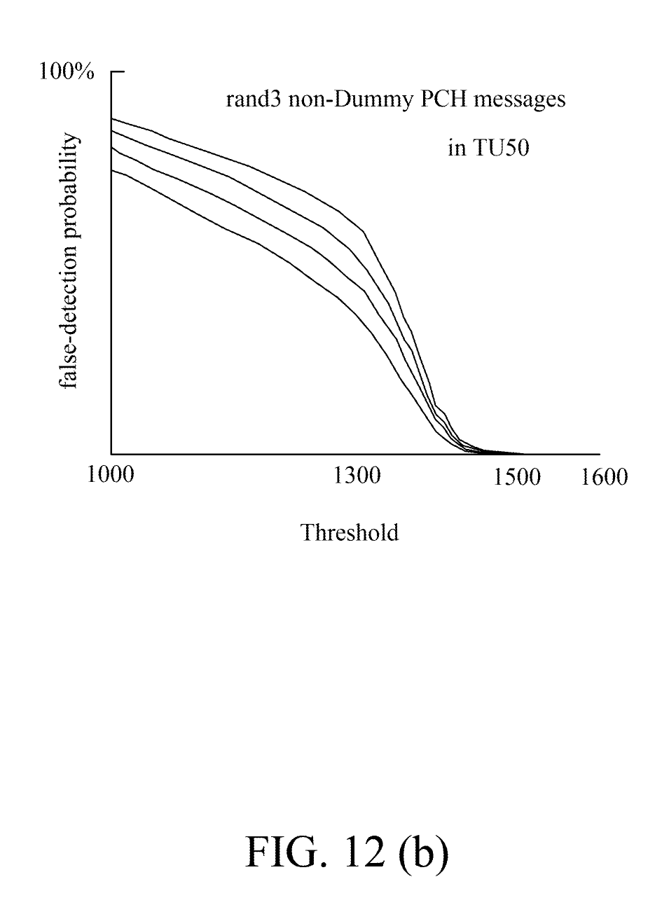

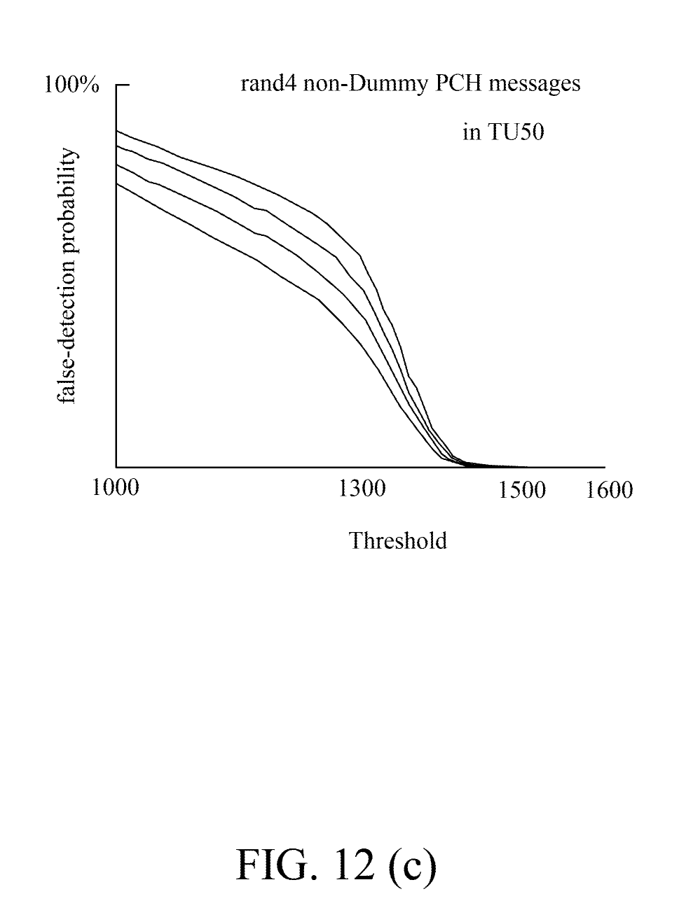

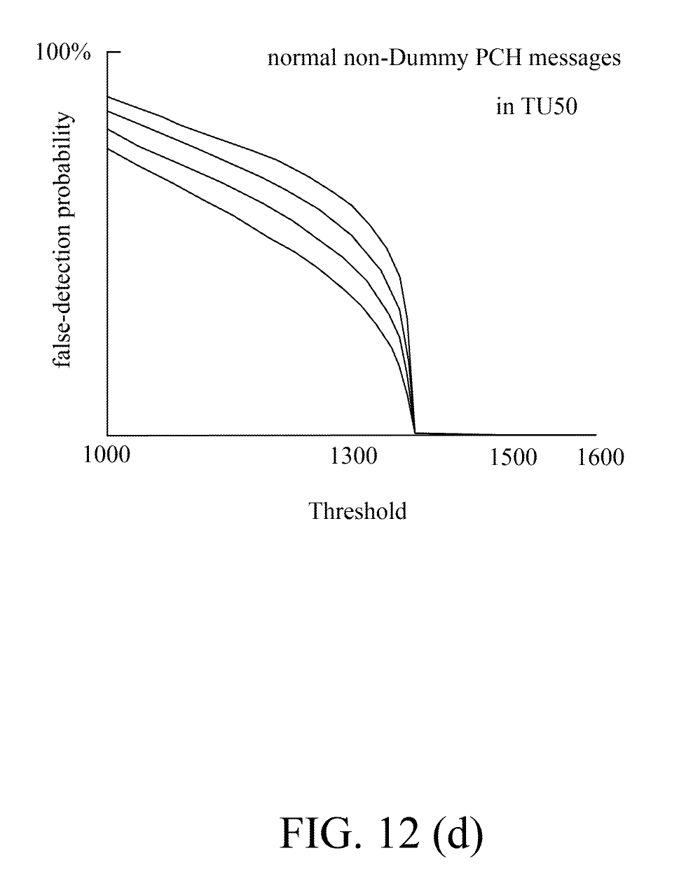

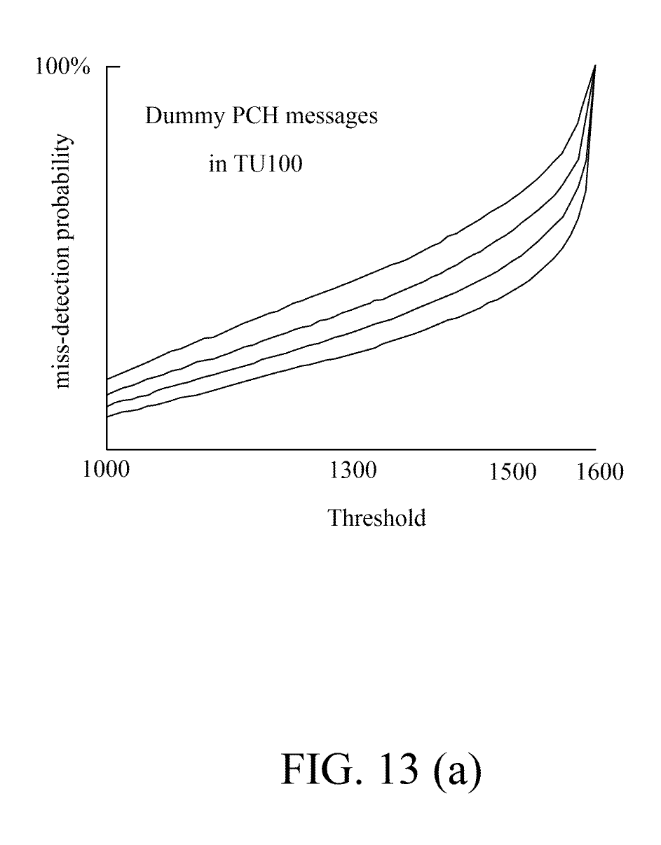

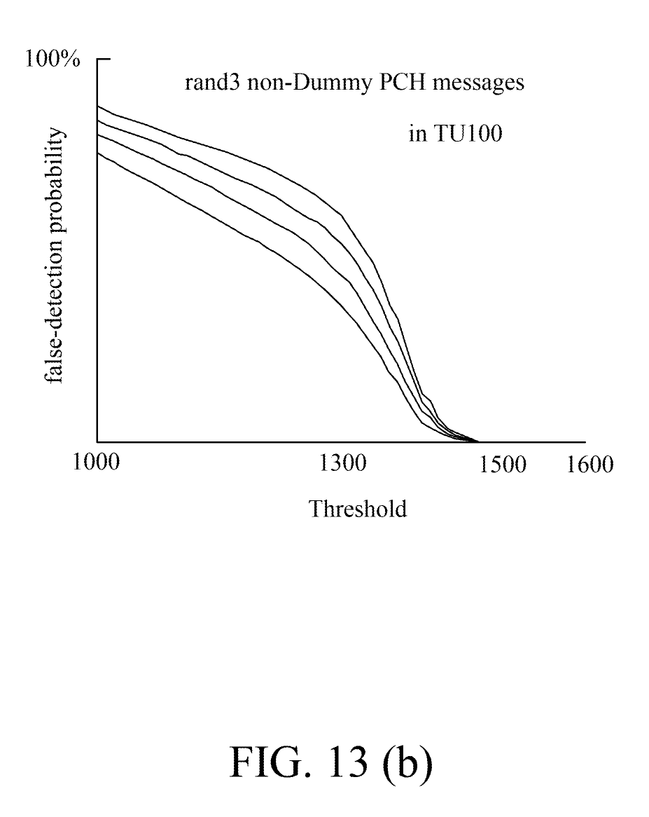

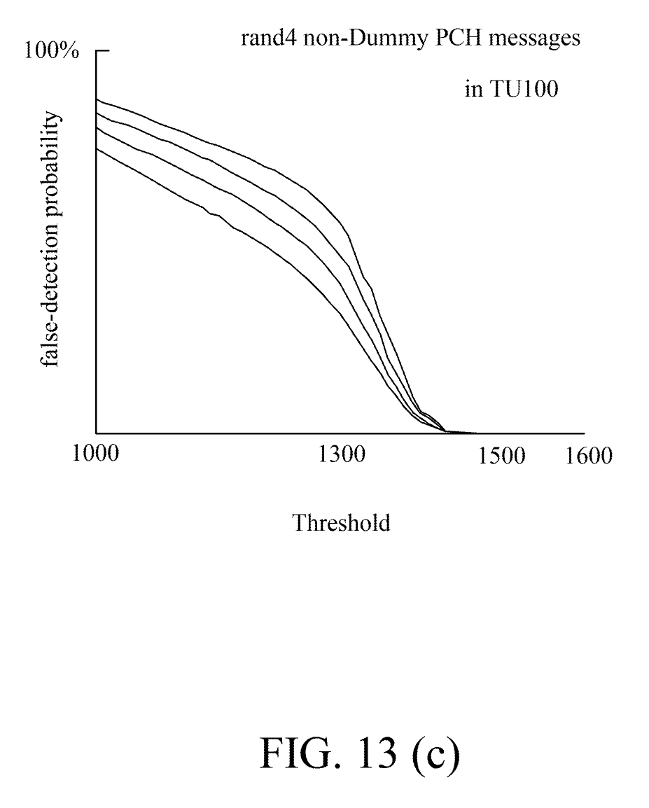

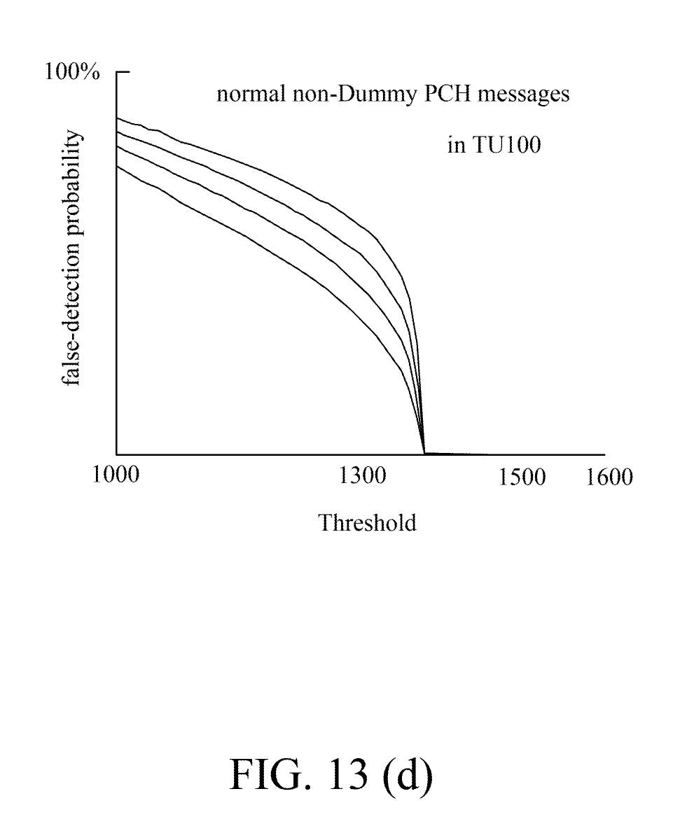

Different simulations have been performed to validate the theoretical value of the dummy paging channel threshold value T. The four simulation corresponding four different channel condition are provided as follow and respectively shown in FIG. 10(a), FIG. 10(b), FIG. 10(c) and FIG. 10(d), FIG. 11(a), FIG. 11(b), FIG. 11(c) and FIG. 11 (d), FIG. 12(a), FIG. 12(b), FIG. 12(c) and FIG. 12(d), and FIG. 13(a), FIG. 13(b), FIG. 13(c) and FIG. 13(d). The channel condition in FIG. 10(a), (b), (c) and (d) is Additive White Gaussian Noise (so-called AWGN). The channel condition in FIG. 11(a), (b), (c) and (d) is TU3. The channel condition in FIG. 12(a), (b), (c) and (d) is TU50. The channel condition in FIG. 13(a), (b), (c) and (d) is TU100. TU3, TU50 and TU100 are the defined channel model in the international standard, such that the detail description thereof is omitted.

The X axis of the abovementioned simulation figures is the dummy paging channel threshold value. The Y axis of the abovementioned figures is the probability of the error detection including miss-detection and false-detection. FIG. 10(a), FIG. 10(b), FIG. 10(c), FIG. 10(d), FIG. 11(a), FIG. 11(b), FIG. 11(c), FIG. 11(d), FIG. 12(a), FIG. 12(b), FIG. 12(c), FIG. 12(d), FIG. 13(a), FIG. 13(b), FIG. 13(c) and FIG. 13(d) respectively include four simulation lines, wherein the different lines within the same figures correspond to different SNR. In simulation of FIG. 10(a), FIG. 11(a), FIG. 12(a) and FIG. 13(a), the base station only transmits dummy PCH messages through burst data, such that FIG. 10(a), FIG. 11(a), FIG. 12(a) and FIG. 13(a) represent the probability of miss-detection with respect to the dummy PCH threshold values. In simulations of FIG. 10(b), FIG. 10(c), FIG. 10(d), FIG. 11(b), FIG. 11(c), FIG. 11(d), FIG. 12(b), FIG. 12(c), FIG. 12(d), FIG. 13(b), FIG. 13(c) and FIG. 13(d), the base station only transmits non-dummy PCH messages through burst data, such that FIG. 10(b), FIG. 10(c), FIG. 10(d), FIG. 11(b), FIG. 11(c), FIG. 11(d), FIG. 12(b), FIG. 12(c), FIG. 12(d), FIG. 13(b), FIG. 13(c) and FIG. 13(d) represent the probability of false-detection with respect to the dummy PCH threshold value.

With respect to the simulation lines in FIG. 10(b), FIG. 11(b), FIG. 12(b) and FIG. 13(b), the transmitted non-dummy PCH message is constructed by randomly selecting 3 bits to be different from a dummy PCH. With respect to the simulation lines in FIG. 10(c), FIG. 11(c), FIG. 12(c) and FIG. 13(c), the transmitted non-dummy PCH message is constructed by randomly selecting 4 bits to be different from a dummy PCH. With respect to the simulation lines in FIG. 10(d), FIG. 11(d), FIG. 12(d) and FIG. 13(d), the transmitted non-dummy PCH message is normal PCH message except the dummy PCH message. From these simulations we can conclude that T=1568 is a satisfying threshold as it does protect us against false-detection in all channel conditions and SNR.

### The Third Embodiment

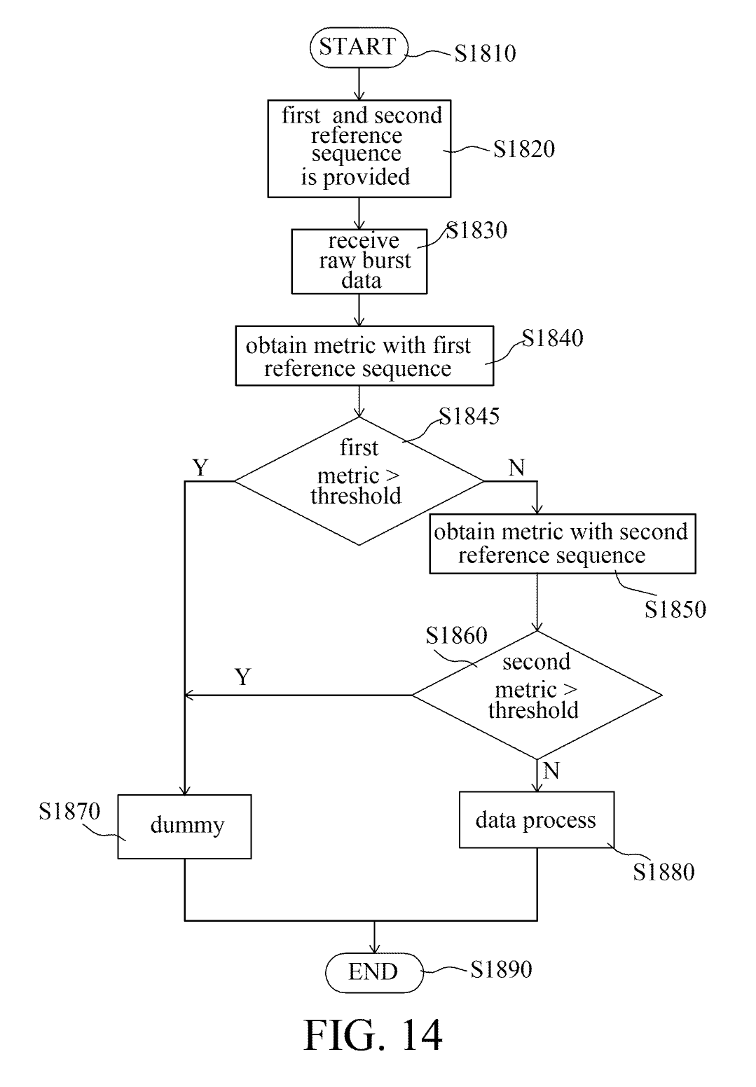

In order to conveniently describe the third embodiment of the present invention, the GSM system is taken for example, and a receiver is used for listening to the Paging Channel (PCH), wherein the receiver is a mobile station (MS) for example. FIG. 14 illustrates a flowchart depicting a method for detecting a dummy PCH message according to the third embodiment of the present invention. Please referring to FIG. 14, the method includes the steps of:

In the step S1810, the method for detecting the dummy PCH message starts.

In the step S1820, a reference dummy PCH burst sequence is provided. In the present embodiment, the reference dummy PCH burst sequence includes a first reference sequence and a second reference sequence. The step S1820 is the same as the step S920, such that the detail description thereof is omitted.

In step S1830, a plurality of raw burst data is received and is equalized. In the standard of GSM system, a valid paging channel message is carried by four consecutive bursts. The step S1830 is the same as the step S930, such that the detail description thereof is omitted.

In the step S1840, each bit of the specific raw burst data is compared with each bit of the first reference sequence to calculate a first metric according to the comparison result thereof. The step S1840 is the same as the step S940 such that the detail description is omitted.

In the step S1845, determining whether the first metric is greater than the dummy PCH threshold value. When the first metric is greater than the dummy PCH threshold value, the step S1870 is performed. When the first metric is smaller than or equal to the dummy PCH threshold value, the step S1850 is performed.

In the step S1850, each bit of the specific raw burst data is compared with each bit of the second reference sequence to calculate a second metric according to the comparison result thereof. The step S1850 is the same as the step S950, such that the detail description is omitted.

In the step S1860, determining whether the second metric is greater than the dummy PCH threshold value. When the second metric is greater than the dummy PCH threshold value, the step S1870 is performed. When the second metric is smaller than or equal to the dummy PCH threshold value, the step S1880 is performed.

In the step S1870, it is determined that the raw burst data is the dummy PCH message when the first metric or the second metric is greater than the dummy PCH threshold value. When the mobile station determines that the paging request carried by the raw burst data is the dummy paging channel message, the mobile station ignores the raw burst data instead of performing de-interleaving, decoding and error correction, etc. . . . . The amount of the data process of the mobile station can be therefore reduced, and also the bandwidth waste and the power consumption can be reduced.

In the step S1880, when the second metric is smaller than or equal to the dummy paging channel threshold value, a conventional data process is performed, such as de-interleaving, decoding, and/or error correction and so on. The step S1880 is the same as the step S980 such that the detail description is omitted.

In the step S1890, the method for detecting dummy PCH ends.

The difference between the third embodiment and the second embodiment is that the third embodiment determines whether the first metric is greater than the dummy PCH threshold value in advance. When the first metric is greater than the dummy PCH threshold value, it is determined that the paging request in the raw burst data is the dummy PCH message such that the calculation of the second metric would not be necessary.

### The Fourth Embodiment

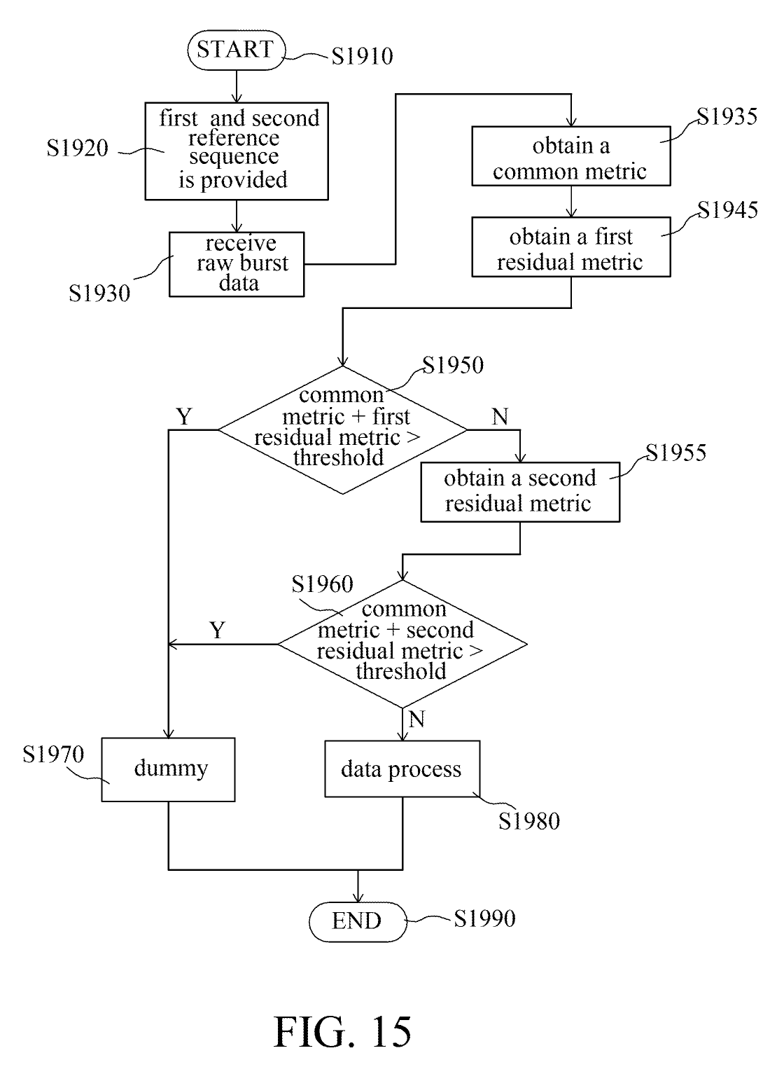

In order to conveniently describe the fourth embodiment of the present invention, the GSM system is also taken for example, and a receiver is used for listening to the Paging Channel (PCH), wherein the receiver is a mobile station (MS) for example. FIG. 15 illustrates a flow chart depicting a method for detecting a dummy paging channel message according to the fourth embodiment of the present invention. Please referring to FIG. 15, the method includes the step of:

In the step S1910, the method for detecting a dummy PCH message starts.

In the step S1920, a reference dummy PCH burst sequence is provided. In the present embodiment, the reference dummy PCH burst sequence includes a first reference sequence and a second reference sequence. Because the step S1920 is the same as the step S920, the detail description is omitted.

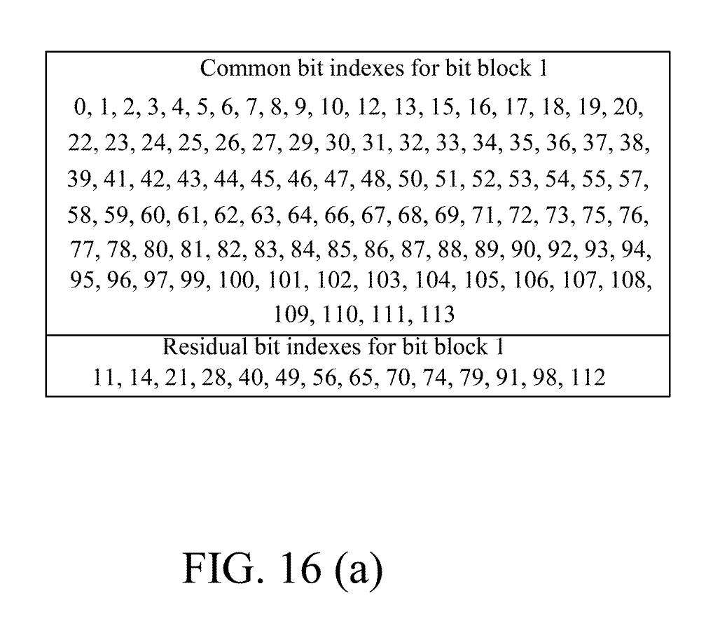

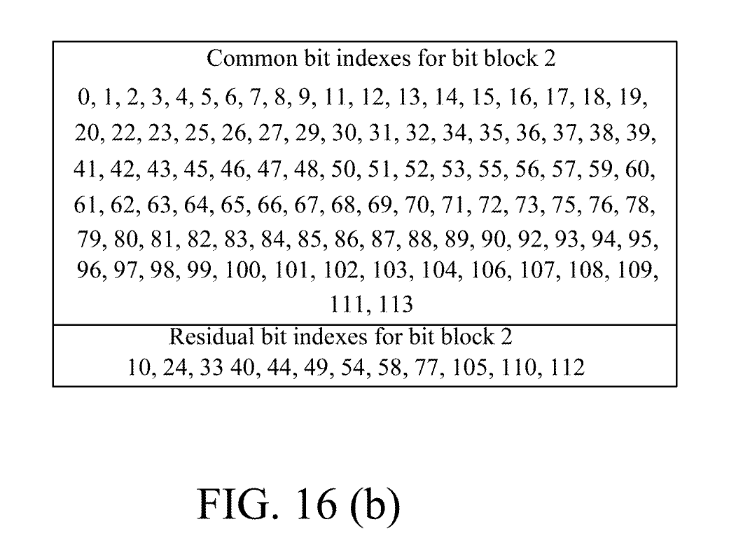

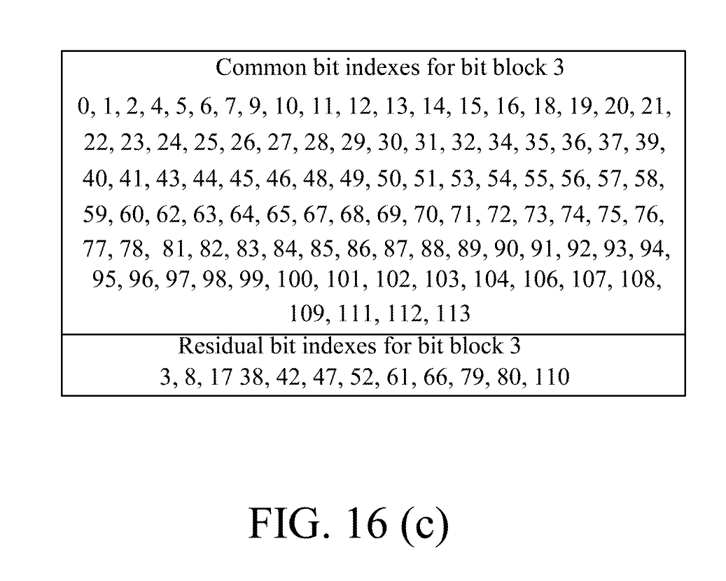

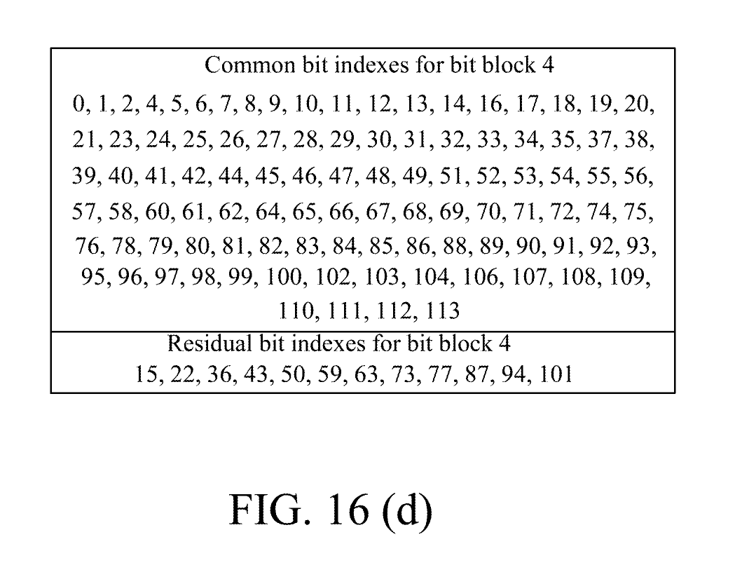

According to the description for the step S920, the dummy PCH message has two fixed patterns (called a first type dummy PCH message and a second type dummy PCH message). Also, the bit difference between the first type dummy PCH message and the second type dummy PCH message is only 4 bits. Thus, the four bit blocks generated by the first type dummy PCH message and the four bit blocks generated by the second type dummy PCH message have very high similarity (illustrated in FIGS. 7 and 8). Each bit of the four bit blocks generated by the first type reference dummy PCH message and the second type reference dummy PCH message has its corresponding bit index according to its order. Moreover, the bits in the i^{th} bit block generated by first type dummy PCH message and the bits in the i^{th} bit block generated by the second dummy PCH message comprise the common bits and the residual bits. The common bits means that the bits in the i^{th} bit block generated by the first type dummy PCH message are the same logic as the bits in the i^{th} bit block generated by the second type dummy PCH message and the bit indexes of the common bits in the i^{th} bit block generated by the first type dummy PCH message are the same as the bit indexes of the common bits in the i^{th} bit block generated by the second type dummy PCH message. The residual bits means that the bits in the i^{th} bit block generated by the first type dummy PCH message are totally different from the bits in the i^{th} block generated by the second type dummy PCH message and the bit indexes of the residual bits in the i^{th} block generated by the first type PCH channel message are the same as the bit indexes of the residual bits in the i^{th} block generated by the second type dummy PCH message, wherein “i” is a nature number between 1 and 4. The bit indexes can be divided into the common bit indexes and the residual bit indexes. The bit indexes of the common bits is the common bit index, the bit indexes of the residual bits is the residual bit indexes. The common bit indexes and the residual bit indexes of the bit indexes in bit blocks 1-4 are individually illustrated in FIG. 16(a), FIG. 16(b), FIG. 16(c) and FIG. 16(d). As shown in FIG. 16(a), (b), (c) and (d), each bit block has 114 bits, and its bit indexes are arranged from 0 to 113.

In the step S1930, a plurality of raw burst data are received and the plurality of raw burst data are equalized. In the specification of the GSM system, a valid paging channel message is carried by four consecutive bursts. Thus, the mobile station would receive at least four raw burst data, wherein one of the raw burst data would be served as a specific raw burst data. The specific raw burst data would be used to determine whether the multiple raw burst data carried the dummy paging channel message or not. In addition, the equalized specific raw burst data has 114 bits.

In the step S1935, a common metric is calculated by comparing each bit of the common bit indexes of the specific raw burst data with each bit of the common bit indexes of the first reference sequence. Taking the bit block 1 for example, according to FIG. 16(a), the bit block 1 has 100 common bit indexes. The bit index 0 is the common bit index such that the first bit of the specific raw burst data is used to compare with the first bit of the bit index 0 of the first reference sequence, and a score is obtained according to FIG. 9. On the analogy of this, the bit indexes 1, 2, 3, 4, 5, 6, 7, 8, 9 and 10 are the common bit indexes, and thus the second to the tenth bits of the specific raw burst data would be respectively taken to compare with the corresponding bits of the bit indexes 1, 2, 3, 4, 5, 6, 7, 8, 9 and 10 of the first reference sequence and the scores thereof are respectively obtained. Because the bit index 11 is the residual bit index, the bit of the bit index 11 would be skipped in the step S1935 and then the bit of the bit index 12 would be used to calculate the corresponding score. Finally, the sum of the scores for the each common bit of common bit indexes of the specific raw burst data is the common metric.

In the step S1945, a first residual metric is calculated by comparing each raw bit of the residual bit indexes of the specific raw burst data with each bit of the residual bit indexes of the first reference sequence. Taking the bit block 1 for example, according to FIG. 16, the burst 1 has 14 residual bit indexes. The bit index 11 is the residual bit index such that the twelfth bit of the bit index 11 of the specific raw burst data is used to compare with the twelfth bit of the bit index 11 of the first reference sequence, and a score thereof is obtained according to FIG. 9. On the analogy of this, the bit indexes 14, 21, 28, 40, 49, 56, 65, 70, 74, 79, 91, 98 and 112 are the residual bit indexes, and thus the bits of the abovementioned residual bit indexes of the specific raw burst data would be taken to compare with the bits of the abovementioned residual bit of the first reference sequence and the scores thereof are respectively obtained. Finally, the sum of the scores for the each residual bit of residual bit indexes of the specific raw burst data is the first residual metric.

In the step S1950, it is determined whether the sum of the common metric and the first residual metric is greater than the dummy PCH threshold value. The sum of the common metric and the first residual metric is the above-mentioned first metric in the abovementioned embodiment. When the sum of the common metric and the first residual metric is greater than the dummy PCH threshold value, the step S1970 is performed. When the sum of the common metric and the first residual metric is smaller than or equal to the dummy paging channel threshold value, the step S1955 is performed.

In the step S1955, a second residual metric is calculated by comparing each raw bit of the residual bit indexes of the specific raw burst data with each bit of the residual bit indexes of the second reference sequence. The step S1955 is similar to the step S1945 such that the detail description thereof is omitted.

In the step S1960, it is determined whether the sum of the common metric and the second residual metric is greater than the dummy PCH threshold value. The sum of the common metric and the second residual metric is the above-mentioned second metric in the abovementioned embodiment. When the sum of the common metric and the second residual metric is greater than the dummy PCH threshold value, the step S1970 is performed. When the sum of the common metric and the second residual metric is smaller than or equal to the dummy PCH threshold value, the step S1980 is performed.

In the step S1970, it is determined the raw burst data is the dummy PCH message. When the receiver determines that the paging request carried by the raw burst data is the dummy paging channel message, the receiver would ignore the raw burst data instead of de-interleaving, decoding, and/or error correction and so on. The amount of the data process in the receiver is thus reduced. And the bandwidth waste and the power consumption thereof are also reduced.

In the step S1980, the sum of the common metric and the second residual metric is smaller than or equal to the dummy PCH threshold value, a conventional data process is performed, such as de-interleaving, decoding, and/or error correction and so on. The step S1980 is the same as the step S980 such that the detail description thereof is omitted.

In the step S1990, the method for detecting dummy paging channel message ends.

The difference between fourth embodiment and the third embodiment is the common metric is calculated in advance such that only a few amounts of the scores of the residual bits in the step S1955 is calculated to obtain the second residual metric when calculating the second metric. Therefore, the repeated calculation of the scores of the common bits for obtaining the second metric can be avoided.

### The Fifth Embodiment

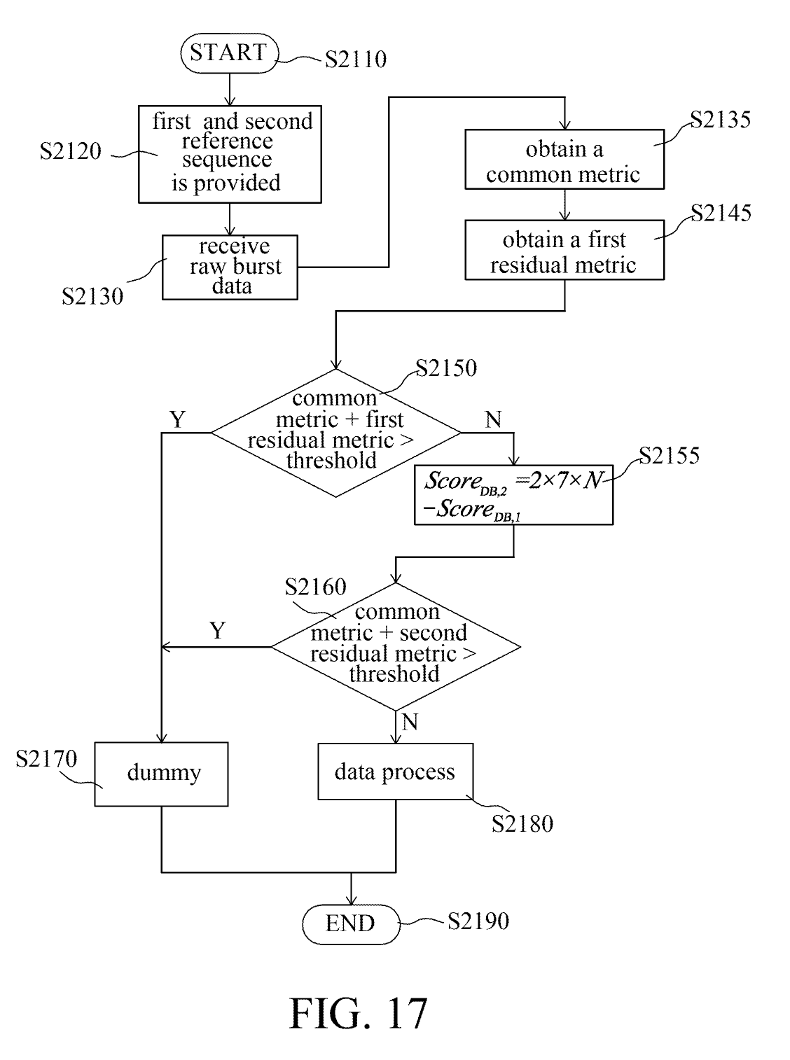

In order to conveniently describe the fifth embodiment of the present invention, the GSM system is also taken for example, and a receiver is used for listening to the Paging Channel (PCH), wherein the receiver is a mobile station (MS) for example. FIG. 17 illustrates a flow chart depicting a method for detecting dummy paging channel message according to the fifth embodiment of the present invention. Please referring to FIG. 17, the method comprises the steps S2110 to S2190. Since the steps S2110 to S2190 is similar to the steps S1910 to S1990 of the fourth embodiment, the detail description for the similar part would be omitted. The difference between the fifth embodiment and the fourth embodiment is the step S2155.

In the step S2155, the second residual metric is calculated. Since the bits of the residual bit indexes of the bit blocks for first reference sequence and the bits of the residual bit indexes of the bit blocks for the second reference sequence are opposite to each other, the second residual metric can be calculated by the following equation:

Score_{DB,2}=2×7×N−Score_{DB,1} (5).

Score_{DB,2} represents the second residual metric, Score_{DB,1} represents the first residual metric, N represent the numbers of the residual bit indexes in the selected bust for the first reference sequence and the second reference sequence. Taking the bit block 1 in FIG. 16 for example, there are 14 residual bit indexes, such that N is equal to 14. If the corresponding raw bits of the residual bit indexes in the specific raw burst data perfectly matches the residual bits of the bit block 1 for the first reference sequence, the total score of the residual bit for perfect match is 2×7×N=2×7×14. Since the bits of the residual bit indexes of the block 1 of the first reference sequence and the bits of the residual bit indexes of the block 1 of the second reference sequence are opposite to each other, the second residual metric is the perfect matching score (2×7×N) minus the first residual metric. In other words, when the second residual metric is calculated, it is unnecessary to calculate the score of each residual bit of the residual bit indexes such that the amount of calculation is reduced.

### The Sixth Embodiment

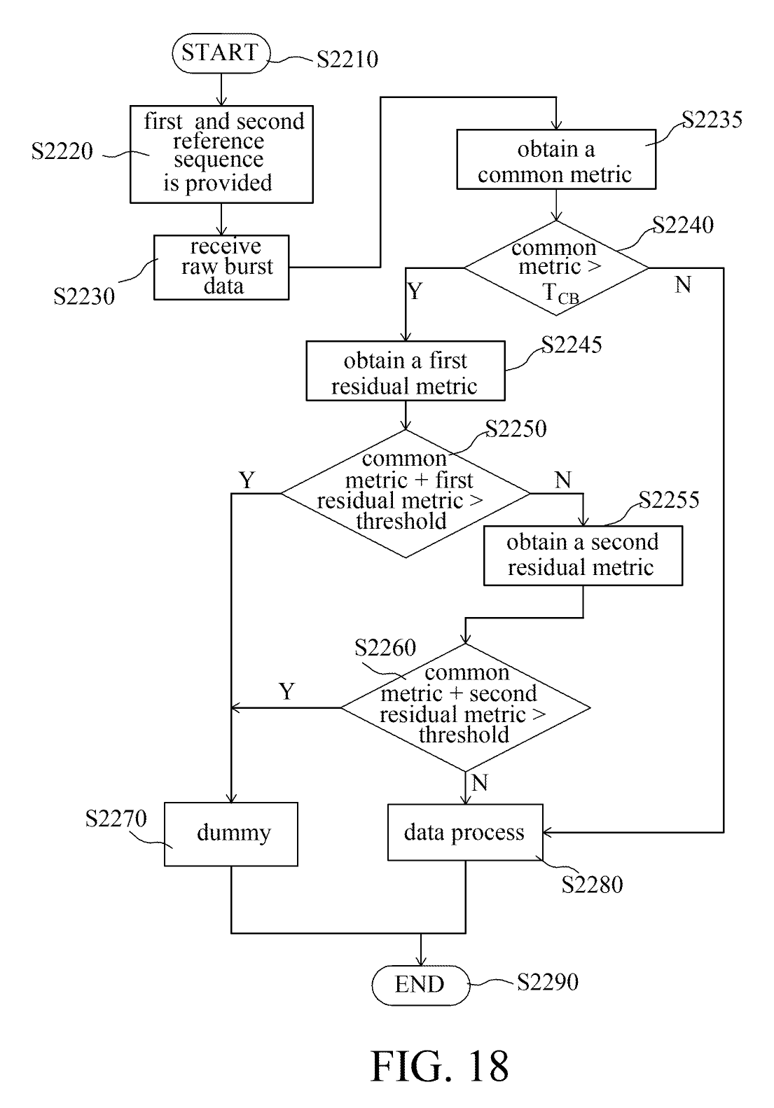

In order to conveniently describe the sixth embodiment, the GSM system is also taken for example, and a receiver is used for listening to the Paging Channel (PCH), wherein the receiver is a mobile station (MS) for example. FIG. 18 illustrates a flow chart depicting a method for detecting a dummy PCH message according to the sixth embodiment of the present invention. Please referring to FIG. 18, the method includes the steps of:

In the steps S2210, the method for detecting dummy PCH message starts.

In the steps S2220, a reference dummy PCH burst sequence is provided. In the present embodiment, the reference dummy PCH burst sequence includes a first reference sequence and a second reference sequence. The step S2220 is the same as the step S1920 such that the detail description thereof is omitted.

In the step S2230, a plurality of raw burst data are received. The step S2230 is the same as the step S1930 such that the detail description thereof is omitted.

In the step S2235, a common metric is calculated by comparing the common bits of the common bit indexes of the first reference sequence with the bits of the common bit indexes of the specific raw burst data. The step S2235 is the same as the step S1935 such that the detail description thereof is omitted.

In the step S2240, it is determined whether the common metric is greater than a common threshold value. When the common metric is greater than the common threshold value, the step S2245 is performed. When the common metric is smaller than or equal to the common threshold value, the step S2280 is performed. The common threshold is represented as T_{CB}. The value of the common threshold is shown below for example.

T_{cB}=2×7×M−Δ

Δ=Score_{perfect}_{_{—}}_{match}−T

wherein T is the abovementioned dummy PCH threshold value, M represent the numbers of the common bit indexes in the selected bust for the first reference sequence and the second reference sequence. Generally speaking, the value of the common threshold T_{CB} can be set within a certain range by system designers or can be adaptively set according to the channel situation. Therefore, the present invention is not limited thereto.

In the step S2245, a first residual metric is calculated by comparing the residual bit of the residual bit indexes of the first reference sequence with the raw bits of the residual bit indexes of the specific raw burst data. The step S2245 is the same as the step S1945 such that the detail description thereof is omitted.

In the step S2250, it is determined whether the sum of the common metric and the first residual metric is greater than the dummy PCH threshold value. The sum of the common metric and the first residual metric is the first metric in the abovementioned embodiment. When the sum of the common metric and the first residual metric is greater than the dummy PCH threshold value, the step S2270 is performed. When the sum of the common metric and the first residual metric is smaller than or equal to the dummy PCH threshold value, the step S2255 is performed.

In the step S2255, a second residual metric is calculated. The second residual metric can be calculated as the description in step S2155 or the description in step S1955 such that the detail description thereof is omitted.

In the step S2260, it is determine whether the sum of the common metric and the second residual metric is greater than the dummy PCH threshold value. The sum of the common metric and the second residual metric is the second metric in the abovementioned embodiment. When the sum of the common metric and the second residual metric is greater than the dummy PCH threshold value, the step S2270 is performed. When the sum of the common metric and the second residual metric is smaller than or equal to the dummy PCH threshold value, the step S2280 is performed.

In the step S2270, it is determined that the raw burst data is the dummy PCH message. When the receiver determines the paging request carried by the raw burst data is the dummy PCH message, the receiver would ignore the raw burst data instead of de-interleaving, decoding and/or error correction and so on. The amount of the data process by the receiver can be reduced. And also, the bandwidth waste and the power consumption thereof are thus reduced.

In the step S2280, a conventional data process is performed, such as de-interleaving, decoding and/or error correction and so on. The step S2280 is the same as the step S980 such that the detail description thereof is omitted.

In the step S2290, the method for detecting dummy PCH message ends.

The difference between the sixth embodiment and the fourth/fifth embodiments is that the common threshold value is set. Because of the common threshold value, the non dummy PCH request can be in advance blocked without calculating the first residual metric or the second residual metric. The data process would be thus reduced.

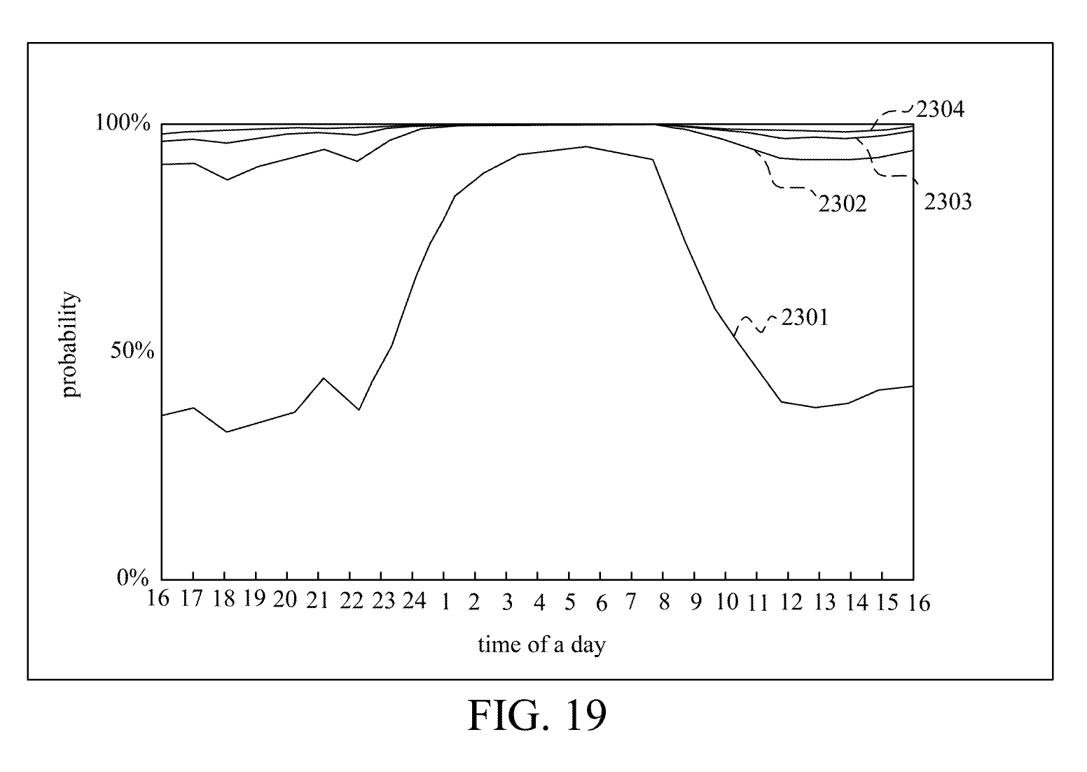

FIG. 19 illustrates a schematic depicting Typical PCH Message Repartition over 24 h in Taiwan or in France according to an embodiment of the present invention. Please referring to FIG. 19, the x-axis is time, and the Y-axis is probability. The region below the label 2301 indicates the probability distribution of the PR1 dummy PCH request with respect to time. The region between the label 2301 and the label 2302 indicates the probability distribution of the normal PR1 PCH request with respect to time. The region between the label 2302 and the label 2303 indicates the probability distribution of the PR2 PCH request with respect to time. The region between label the 2303 and the label 2304 indicates the probability distribution of the normal PR3 PCH request with respect to time. The region upper the label 2304 indicates the probability distribution of the other request with respect to time. As shown in FIG. 19, experiments on different networks in France and Taiwan showed that a vast majority of the PCH messages sent over the network are dummy PCH messages. During daytime the percentage of dummy PCH vary from 30% to 50% (the number will depend on the cell environment—rural/urban —, the network configuration, etc. . . . ). This number will increase dramatically at night, above 90% for most networks, when the number of calls is very low. Since a vast majority of the PCH messages are the dummy PCH message, and the above-mentioned embodiment of the present invention can block the dummy PCH before the data process is performed by the mobile station, the power consumption thereof and the bandwidth waste are greatly reduced and the battery life of the mobile station can be prolonged.

### The Seventh Embodiment

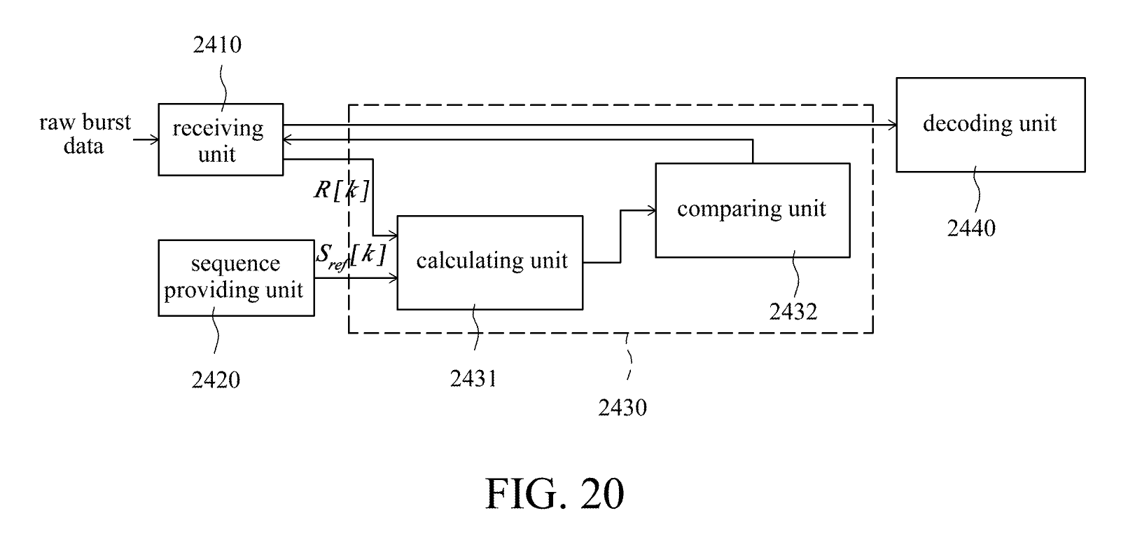

According to the abovementioned embodiments of the present invention, a hardware system for detecting dummy PCH message can be implemented as shown in FIG. 20. FIG. 20 illustrates a block diagram depicting a system for detecting dummy PCH message according to the seventh embodiment of the present invention. Please referring to FIG. 20, the system for detecting dummy PCH message comprises a receiving unit 2410, a sequence providing unit 2420, a determination unit 2430 and a decoding unit 2440. The receiving unit 2410 is used for receiving a plurality of raw burst data and for determining whether the raw burst data is a dummy PCH message according to the output signal of the determination unit. The sequence providing unit 2420 is used for providing a reference dummy PCH burst sequence S_{ref}[k], wherein the detail description for the reference dummy PCH burst sequence is disclosed in the abovementioned embodiments such that the detail description is omitted. Also, the sequence providing unit 2420 can be implemented by a non-volatile memory storing the reference dummy PCH burst sequence. The determination unit 2430 receives the raw burst data R[k] from the receiving unit 2410 and receives the reference dummy PCH burst sequence S_{ref}[k] from the sequence providing unit 2420, and is used for comparing every bits of the reference dummy PCH burst sequence with every bits of a specific raw burst data of the raw burst data to obtain a matching metric according to a comparing result thereof and for determining whether the matching metric is greater than a dummy PCH threshold value, and for outputting a determination signal to the receiving unit. When the matching metric is greater than the dummy PCH threshold value, the determination signal is in a first state. When the matching metric is smaller than or equal to the dummy PCH threshold value, the determination signal is in a second state. The decoding unit 2440 is coupled to the receiving unit 2410 and is used for decoding the raw burst data. When the determination signal is in the first state, the receiving unit 2410 abandons the raw burst data, and when the determination signal is in the second state, the receiving unit 2410 sends the raw burst data to the decoding unit 2440.

The determination unit 2430 comprises a calculating unit 2431 and a comparing unit 2432. The calculating unit 2431 receives the raw burst data R[k] from the receiving unit 2410 and receives the reference dummy PCH burst sequence S_{ref}[k] from the sequence providing unit 2420 to calculating the matching metric Score as the step S850 of the abovementioned first embodiment or as the step S940 and S950 of the abovementioned second embodiment such that the detail description is omitted. The comparing unit 2432 receives the matching metric Score from the calculating unit 2431 for comparing the matching metric Score with the dummy PCH threshold value T to output the determination signal to the receiving unit 2410 as the step S860 of the first embodiment or as the step S960 of the second embodiment.

### The Eighth Embodiment

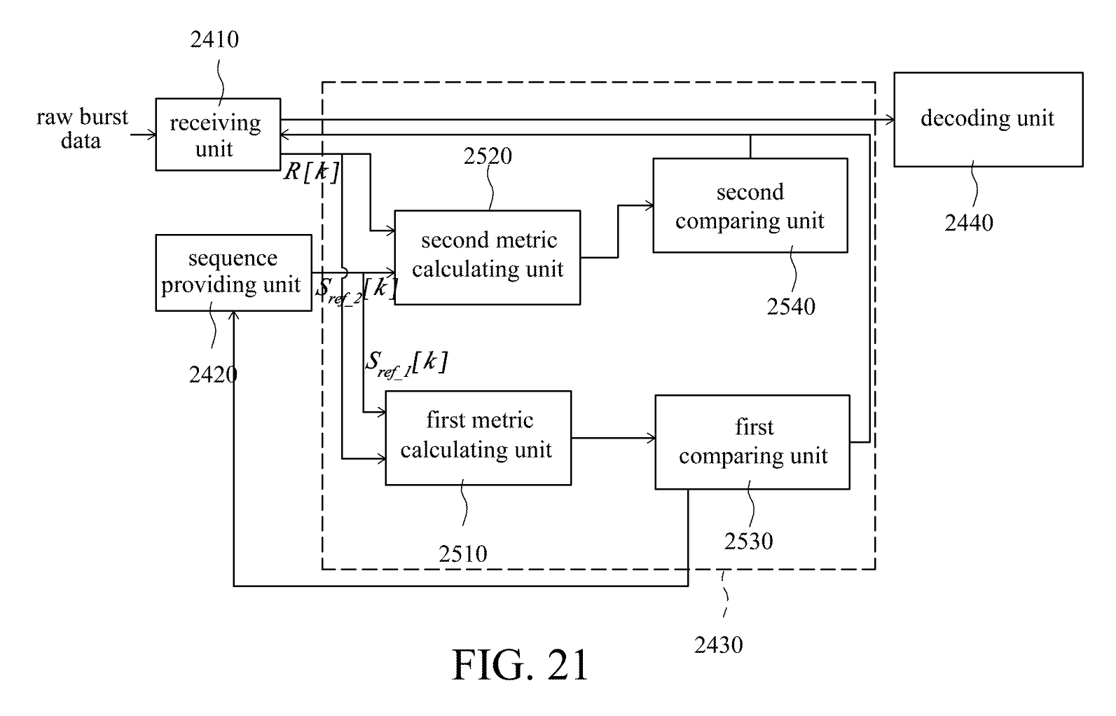

According to the abovementioned embodiments of the present invention, a hardware system for detecting dummy PCH message can be implemented as shown in FIG. 21. FIG. 21 illustrates a block diagram depicting a system for detecting dummy PCH message according to the eighth embodiment of the present invention. Please referring to FIG. 21, the system for detecting dummy PCH message comprises a receiving unit 2410, a sequence providing unit 2420, a determination unit 2430 and a decoding unit 2440, wherein the determination unit 2430 comprises a first metric calculating unit 2510, a second metric calculating unit 2520, a first comparing unit 2530 and a second comparing unit 2540. The first metric calculating unit 2510 receives the first reference burst sequence S_{ref}_{_{—}}₁[k] and the specific raw burst sequence R[k], and is used for calculating the first metric as the step S1840. The first comparing unit 2530 receives the first metric to compare the first metric with the dummy PCH threshold value as the step S1845. When the first metric is greater than the dummy PCH threshold value, the first comparing unit 2530 outputs a determination signal in the first state such that the receiving unit 2410 can abandons the raw burst data as the step S1870. When the first metric is smaller than or equal to the dummy PCH threshold value, the first comparing unit 2530 control the sequence providing unit to provide the second reference sequence to the second metric calculating unit 2520.

The second metric calculating unit 2510 receives the second reference burst sequence S_{ref}_{_{—}}₂[k] and the specific raw burst sequence R[k], and is used for calculating the second metric as the step S1850. The second comparing unit 2540 receives the second metric to compare the first metric with the dummy PCH threshold value as the step S1860. When the second metric is greater than the dummy PCH threshold value, the second comparing unit 2540 outputs a determination signal in the first state such that the receiving unit 2410 can abandons the raw burst data as the step S1870. When the second metric is smaller than or equal to the dummy PCH threshold value, the second comparing unit 2540 outputs a determination signal in the second state, and then the receiving unit 2410 can output the raw burst data to the decoding unit 2440. The decoding unit 2440 can perform the data process as the step S1880.

### The Ninth Embodiment

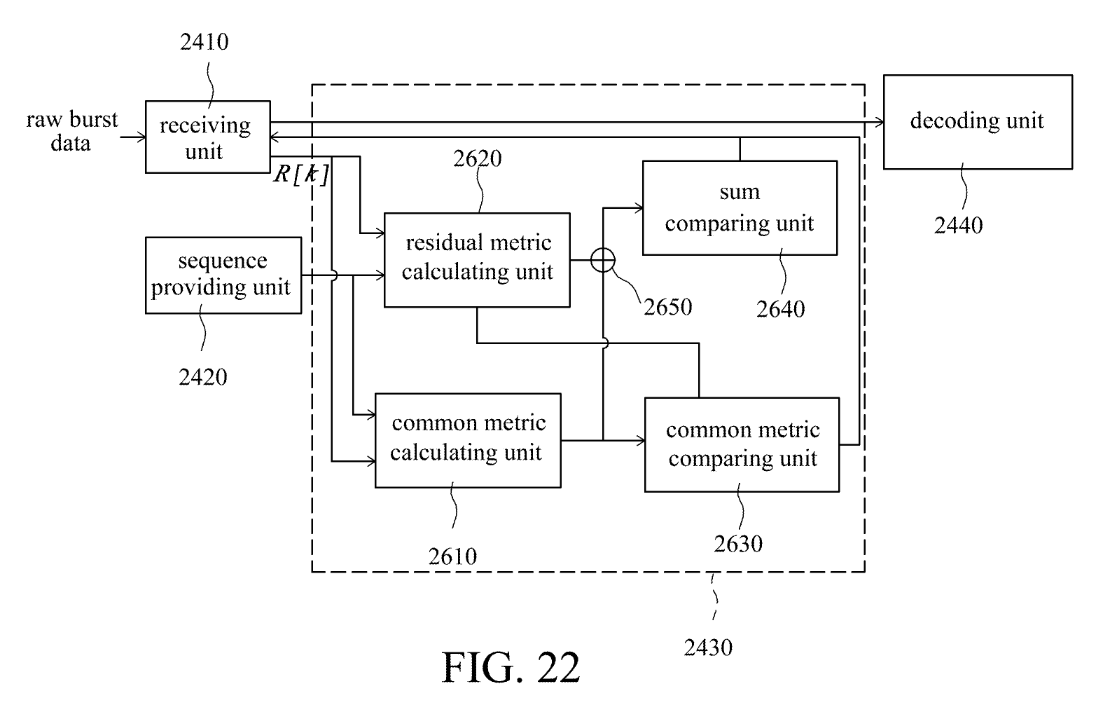

According to the abovementioned embodiments of the present invention, a hardware system for detecting dummy PCH message can be implemented as shown in FIG. 22. FIG. 22 illustrates a block diagram depicting a system for detecting dummy PCH message according to the ninth embodiment of the present invention. Please referring to FIG. 22, the system for detecting dummy PCH message comprises a receiving unit 2410, a sequence providing unit 2420, a determination unit 2430 and a decoding unit 2440, wherein the determination unit 2430 comprises a common metric calculating unit 2610, a residual metric calculating unit 2620, a common metric comparing unit 2630, a sum comparing unit 2640 and a adder 2650. In this embodiment, the sequence providing unit 2420 only used for storing the first reference sequence, common bit indexes and the residual bit indexes. The common metric calculating unit 2610 received the raw burst data R[k] and the common bit of the first reference sequence according to the common bit index storing into the sequence providing unit 2420. The common metric calculating unit 2610 is used for calculating the common metric as the step S2235. The common metric comparing unit 2630 receives the common metric of the common bits to compare the common metric with the common threshold value as the step S2240. When the common metric is smaller than or equal to the common threshold value, the common metric comparing unit 2630 sends the determination signal in the second state such that the raw burst data will be performed the data process by the decoding unit 2440 as the step 2280.

When the common metric is greater than the common threshold value, the common metric comparing unit 2630 control the residual metric calculating unit to calculate the first residual metric as the step 2245, and the adder 2650 performs the first residual metric plus the common metric to obtain the first metric. The sum comparing unit 2640 receives the first metric to compare the first metric with the dummy PCH threshold value as the step S2250. When the first metric is greater than the common PCH threshold value, the sum comparing unit 2640 outputs a determination signal in the first state such that the receiving unit 2410 abandons the raw burst data. When the first metric is smaller than or equal to the common PCH threshold value, the residual metric calculating unit 2620 calculates a second residual metric as the step S2255 or S2155, and the adder 2650 performs the common metric plus the second residual metric to obtain a second metric. The sum comparing unit 2640 receives the second metric to compare the second metric with the dummy PCH threshold value as the step S2260. When the second metric is greater than the dummy PCH threshold value, the sum comparing unit 2640 outputs a determination signal in the first state such that the receiving unit 2410 abandons the raw burst data. When the second metric is smaller than or equal to the common paging channel threshold value, the sum comparing unit 2640 outputs a determination signal in the second state such that the receiving unit 2410 output the raw burst data to the decoding unit 2440. Therefore, the raw burst data is performed the data process by the decoding unit as the step S2280.

### The Tenth Embodiment

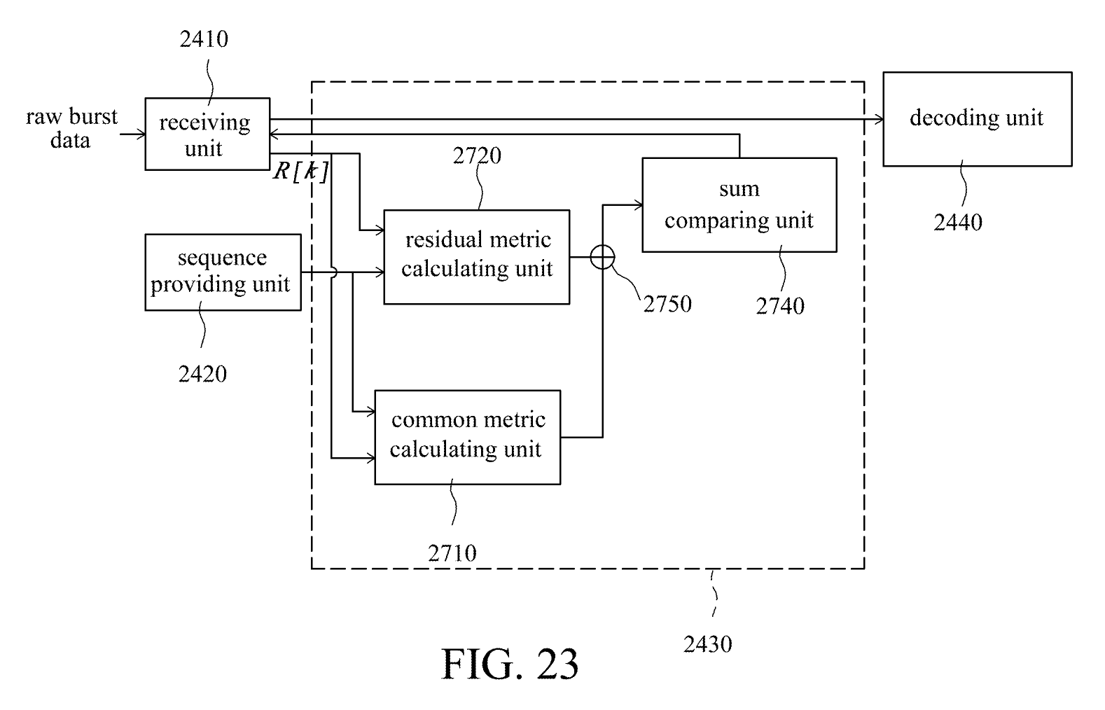

According to the abovementioned embodiments of the present invention, a hardware system for detecting dummy PCH message can be implemented as shown in FIG. 23. FIG. 23 illustrates a block diagram depicting a system for detecting dummy PCH message according to the tenth embodiment of the present invention. Please referring to FIG. 23, the system for detecting dummy PCH message comprises a receiving unit 2410, a sequence providing unit 2420, a determination unit 2430 and a decoding unit 2440, wherein the determination unit 2430 comprises a common metric calculating unit 2710, a residual metric calculating unit 2720, a sum comparing unit 2740 and a adder 2750. In this embodiment, the sequence providing unit 2420 only used for storing the first reference sequence, common bit indexes and the residual bit indexes. The common metric calculating unit 2710 received the raw burst data R[k] and the common bit of the first reference sequence according to the common bit index storing into the sequence providing unit 2420. The common metric calculating unit 2710 is used for calculating the common metric.

The residual metric calculating unit 2720 to calculate the first residual metric as the step S1945, and the adder 2750 performs the first residual metric plus the common metric to obtain the first metric. The sum comparing unit 2740 receives the first metric to compare the first metric with the dummy PCH threshold value as the step S1950. When the first metric is greater than the dummy PCH threshold value, the sum comparing unit 2640 outputs a determination signal in the first state such that the receiving unit 2410 abandons the raw burst data. When the first metric is smaller than or equal to the common PCH threshold value, the residual metric calculating unit 2720 calculates a second residual metric as the step S1955 or S2155, and the adder 2750 performs the common metric plus the second residual metric to obtain a second metric. The sum comparing unit 2740 receives the second metric to compare the second metric with the dummy PCH threshold value as the step S2160. When the second metric is greater than the dummy PCH threshold value, the sum comparing unit 2740 outputs a determination signal in the first state such that the receiving unit 2410 abandons the raw burst data. When the second metric is smaller than or equal to the dummy PCH threshold value, the sum comparing unit 2740 outputs a determination signal in the second state such that the receiving unit 2410 output the raw burst data to the decoding unit 2440. Therefore, the raw burst data is performed the data process by the decoding unit as the step S2180.

In the present invention, the system and method for detecting dummy PCH message can be applied to a single-SIM modem environment or a multi-SIM modem environment. In the single-SIM modem environment, one of 4 bit block (bursts) generated by the abovementioned first type dummy PCH message is selected as a first reference sequence for dummy PCH message detection. If the first bit block is selected, the 1^{st} raw burst data has to be processed for dummy PCH message detection, such that the system for detecting dummy PCH message is at least stored the first bit block for first type dummy PCH message, index table for the common bit indexes and the residual bit indexes in first bit block, and common threshold T_{CB}.

In the multi-SIM environment, the radio resource might not be available for the 1^{st} raw burst data of the PCH reception because it is used for another process from another SIM. This is however not an issue as the dummy PCH detection. In a multi-SIM environment, the dummy PCH detection can be performed the same way on any single burst among the 4 raw burst data that comprise a PCH message, and one parameter is introduced into the present invention. The parameter is to indicate on which one of the 4 bursts is the detection performed, and the system for detecting dummy PCH message in the multi-SIM environment is required to store the bit blocks, index tables, and common thresholds T_{CB} for all 4 PCH bursts.

In summary, the present invention takes the raw burst data to compare with the sequence generates from the standard dummy PCH message such that the result thereof is used for determining whether the raw burst data is the dummy PCH message. Thus, the dummy PCH message can be blocked before de-interleaving, decoding and/or error correction and so on. The power consumption and the bandwidth waste of the mobile station can be greatly reduced. Also the battery life of the mobile station can be therefore prolonged.

While certain exemplary embodiments have been described and shown in the accompanying drawings, it is to be understood that such embodiments are merely illustrative of and not restrictive on the broad invention, and that this invention should not be limited to the specific construction and arrangement shown and described, since various other modifications may occur to those ordinarily skilled in the art.

What is claimed is:

1. A method for detecting dummy paging channel message, adapted for a mobile station, comprising:
providing a reference dummy paging channel burst sequence;
when a plurality of raw burst data is received, the method comprising:
comparing every bits of the reference dummy paging channel burst sequence and every bits of a specific raw burst data of the raw burst data to obtain a matching metric according to a comparing result thereof; and
determining the raw burst data is a dummy paging channel message if the matching metric is greater than a dummy paging channel threshold value.

2. The method for detecting dummy paging channel message according to claim 1, wherein the k^{th} bit of the specific raw burst data is represented as R[k], wherein R[k] is an integer between A and −A, and the length of raw burst data R[k] represent as L, wherein A and L are nature numbers, and k is an integer, kε{0, L−1}.

3. The method for detecting dummy paging channel message according to claim 2, wherein the k^{th} bit of the reference dummy paging channel burst sequence is represented as S_{ref}|k|, wherein S_{ref}[k]ε{0,1}, and the length of the reference dummy paging channel burst sequence is L, wherein the matching metric is represented as Score, wherein
$$Score = {\sum }_{k = 0}^{L - 1} [ A + R [ k ] \cdot ( 2 \cdot {S}_{ref} [ k ] - 1 ) ] .$$

4. The method for detecting dummy paging channel message according to claim 3, wherein the dummy paging channel threshold value is represented as T, wherein the value of T is between Score_{perfect}_{_{—}}_{match} and Score_{perfect}_{_{—}}_{match}−Dₘᵢₙ×2A, wherein Score_{perfect}_{_{—}}_{match} is the maximum value of the matching metric, wherein the maximum value of the matching metric is equal to L×2A, wherein Dₘᵢₙ is the minimum Hamming distance, and Dₘᵢₙ is an integer.

5. The method for detecting dummy paging channel message according to claim 4, wherein the dummy paging channel threshold value T is represented as,
T=Score_{perfect}_{_{—}}_{match}−Dₘᵢₙ×A.

6. The method for detecting dummy paging channel message according to claim 4, wherein the minimum Hamming distance Dₘᵢₙ is a minimum bit difference between a j^{th} bit block which is produced by a dummy paging channel message and a j^{th} bit block which is produced by a non-dummy paging channel message.

7. The method for detecting dummy paging channel message according to claim 6, wherein the minimum Hamming distance Dₘᵢₙ is greater than or equal to 4.

8. The method for detecting dummy paging channel message according to claim 1, wherein the reference dummy paging channel burst sequence comprises a first reference sequence and a second reference sequence, and the method further comprises:
comparing each bit of the specific raw burst data of the raw burst data and each bit of the first reference sequence to calculate a first metric.

9. The method for detecting dummy paging channel message according to claim 8, wherein to obtain the first reference sequence comprises:
providing a first type dummy paging channel message;
encoding the first type dummy paging channel message with a fire code to obtains a plurality of first fire coded bits;
encoding the plurality of first fire coded bits with a convolution code to obtain a plurality of first encoded bits; and
interleaving the plurality of first encoded bits to obtain a plurality of first reference bit blocks,
wherein, when the specific raw burst data in the raw burst data is the i^{th} raw burst data, a i^{th} bit block of the first reference bit blocks is the first reference sequence.

10. The method for detecting dummy paging channel message according to claim 8, further comprising:
determining whether the raw burst data is the dummy paging channel message according to the first metric and the dummy paging channel threshold value; and
determining the raw burst data is the dummy paging channel message if the first metric is greater than the dummy paging channel threshold value;
comparing each bit of the specific raw burst data of the raw burst data with the second reference sequence to obtain a second metric if the first metric is smaller than or equal to the dummy paging channel threshold value;
determining whether the raw burst data is the dummy paging channel message according to the second metric and the dummy paging channel threshold value; and
determining the raw burst data is the dummy paging channel message if the second metric is greater than the dummy paging channel threshold value.

11. The method for detecting dummy paging channel message according to claim 8, further comprising:
comparing each bit of the specific raw burst data of the raw burst data with the second reference sequence to obtain a second metric;
determining whether a greater metric from the first metric and the second metric is greater than the dummy paging channel threshold value; and
determining the raw burst data is the dummy paging channel message if the greater metric from the first metric and the second metric is greater than the dummy paging channel threshold value.

12. The method for detecting dummy paging channel message according to claim 8, wherein to obtain the second reference sequence comprises:
providing a second type dummy paging channel message;
encoding the second type dummy paging channel message with a fire code to obtains a plurality of second fire coded bits;
encoding the plurality of second fire coded bits with a convolution code to obtain a plurality of second encoded bits; and
interleaving the plurality of second encoded bits to obtain a plurality of second reference bit blocks,
wherein, when the specific raw burst data of the raw burst data is the i^{th} raw burst data, the i^{th} bit block of the second reference bit blocks is the second reference sequence.

13. The method for detecting dummy paging channel message according to claim 1, wherein the reference dummy paging channel burst sequence comprises a first reference sequence and a second reference sequence, wherein the first reference sequence and the second reference sequence respectively comprise L bits, the L bits of the first reference sequence and the L bits of the second reference sequence respectively has L bit indexes, wherein the bit index of the i^{th} bit of the first reference sequence and the bit index of the i^{th} bit of the second reference sequence respectively are (i−1), wherein “i” and “L” are integers, and 0<=i<L.

14. The method for detecting dummy paging channel message according to claim 13, wherein the bit indexes comprise M common bit indexes and N residual bit indexes, wherein the bits in positions of the common bit indexes of the first reference sequence are the same as the bits in positions of the common bit indexes of the second reference sequence, wherein the bits in positions of the residual bit indexes of the first reference sequence are different from the bits in positions of the residual bit indexes of the second reference sequence, the method further comprises:
comparing every bits in the positions of the common bit indexes of the specific raw burst data the with the bits in the positions of the common bit indexes of the first reference sequence to calculate a common metric.

15. The method for detecting dummy paging channel message according to claim 14, further comprises:
comparing every bits in the positions of the residual bit indexes of the specific raw burst data the with the bits in the positions of the residual bit indexes of the first reference sequence to calculate a first residual metric when the common metric is greater than a common threshold value; and
determining the raw burst data is the dummy paging channel message when a sum of the common metric and the first residual metric is greater than the dummy paging channel threshold value.

16. The method for detecting dummy paging channel message according to claim 15, when the sum of the common metric and the first residual metric is smaller than or equal to the dummy paging channel threshold value, the method further comprising:
comparing every bits in the positions of the residual bit indexes of the specific raw burst data the with the bits in the positions of the residual bit indexes of the second reference sequence to calculate a second residual metric; and
determining the raw burst data is the dummy paging channel message when a sum of the common metric and the second residual metric is greater than the dummy paging channel threshold value.

17. The method for detecting dummy paging channel message according to claim 15, wherein the first residual metric is represented as Score_{DB,1}, and a second residual metric is represented as Score_{DB,2}, the second residual metric can be calculated as following equation:
Score_{DB,2}=2A×N−Score_{DB,1},
wherein the bit of the specific raw burst data is an integer between A and −A, wherein “A” is a nature number,
wherein, when the sum of the common metric and the first residual metric is smaller than or equal to the dummy paging channel threshold value, the method further comprises:
calculating the second residual metric according to the equation:
Score_{DB,2}=2A×N−Score_{DB,1};
determining the raw burst data is the dummy paging channel message when a sum of the common metric and the second residual metric is greater than the dummy paging channel threshold value.

18. The method for detecting dummy paging channel message according to claim 14, further comprises:
comparing every bits in the positions of the residual bit indexes of the specific raw burst data the with the bits in the positions of the residual bit indexes of the first reference sequence to calculate a first residual metric;
determining the raw burst data is the dummy paging channel message when a sum of the common metric and the first residual metric is greater than the dummy paging channel threshold value.

19. The method for detecting dummy paging channel message according to claim 18, when the sum of the common metric and the first residual metric is smaller than or equal to the dummy paging channel threshold value, further comprises:
comparing every bits in the positions of the residual bit indexes of the specific raw burst data the with the bits in the positions of the residual bit indexes of the second reference sequence to calculate a second residual metric; and
determining the raw burst data is the dummy paging channel message when a sum of the common metric and the second residual metric is greater than the dummy paging channel threshold value.

20. The method for detecting dummy paging channel message according to claim 18, wherein the first residual metric is represented as Score_{DB,1}, and a second residual metric is represented as Score_{DB,2}, the second residual metric can be calculated as following equation:
Score_{DB,2}=2A×N−Score_{DB,1},
wherein the bit of the specific raw burst data is an integer between A and −A, wherein “A” is a nature number,
wherein, when the sum of the common metric and the first residual metric is smaller than or equal to the dummy paging channel threshold value, the method further comprises:
calculating the second residual metric according to the equation:
Score_{DB,2}=2A×N−Score_{DB,1};
determining the raw burst data is the dummy paging channel message when a sum of the common metric and the second residual metric is greater than the dummy paging channel threshold value.

21. The method for detecting dummy paging channel message according to claim 1, further comprising:
abandoning the raw burst data when the matching metric is greater than the dummy paging channel threshold value.

22. A system for detecting dummy paging channel message, comprising:
a receiving unit, for receiving a plurality of raw burst data;
a sequence providing unit, for providing a reference dummy paging channel burst sequence;
a determination unit, respectively coupled to the receiving unit and the sequence providing unit, for comparing every bits of the reference dummy paging channel burst sequence with every bits of a specific raw burst data of the raw burst data to obtain a matching metric according to a comparing result thereof, and for determining whether the matching metric is greater than a dummy paging channel threshold value, and for outputting a determination signal to the receiving unit, wherein the determination signal is in a first state when the matching metric is greater than the dummy paging channel threshold value, the determination signal is in a second state when the matching metric is smaller than or equal to the dummy paging channel threshold value; and
a decoding unit, coupled to the receiving unit, for decoding the raw burst data,
wherein the receiving unit abandons the raw burst data when the determination signal is in the first state and the receiving unit send the raw burst data to the decoding unit when the determination signal is in the second state.

23. The system for detecting dummy paging channel message according to claim 22, wherein the sequence providing unit is implemented by a non-volatile memory.

24. The system for detecting dummy paging channel message according to claim 22, wherein the determination unit comprises:
a calculating unit, respectively coupled to the receiving unit and the sequence providing unit, for calculating the matching metric by comparing every bits of the reference dummy paging channel burst sequence with every bits of the specific raw burst data of the raw burst data; and
a comparing unit, respectively coupled to the calculating unit and the receiving unit, for receiving the matching metric to compare the matching metric with the dummy paging channel threshold value such that the comparing result is outputted to the receiving unit.

25. The system for detecting dummy paging channel message according to claim 24, wherein the k^{th} bit of the specific raw burst data is represented as R[k], wherein R[k] is an integer between A and −A, and the length of raw burst data R[k] represent as L, wherein A and L are nature numbers, and k is an integer, kε{0, L−1}.

26. The system for detecting dummy paging channel message according to claim 25, wherein the k^{th} bit of the reference dummy paging channel burst sequence is represented as S_{ref}[k], wherein S_{ref}[k]ε{0,1}, and the length of the reference dummy paging channel burst sequence is L, wherein the matching metric is represented as Score, wherein the calculating unit performs the following equation:
$$Score = {\sum }_{k = 0}^{L - 1} [ A + R [ k ] \cdot ( 2 \cdot {S}_{ref} [ k ] - 1 ) ] .$$

27. The system for detecting dummy paging channel message according to claim 26, wherein the dummy paging channel threshold value is represented as T, wherein the value of T is between Score_{perfect}_{_{—}}_{match} and Score_{perfect}_{_{—}}_{match}−Dₘᵢₙ×2A, wherein Score_{perfect}_{_{—}}_{match} is the maximum value of the matching metric, wherein the maximum value of the matching metric is equal to L×2A, wherein Dₘᵢₙ is the minimum Hamming distance, and Dₘᵢₙ is an integer.

28. The system for detecting dummy paging channel message according to claim 27, wherein the dummy paging channel threshold value T is represented as,
T=Score_{perfect}_{_{—}}_{match}−Dₘᵢₙ×A.

29. The system for detecting dummy paging channel message according to claim 27, wherein the minimum Hamming distance Dₘᵢₙ is a minimum bit difference between a j^{th} bit block which is produced by a dummy paging channel message and a j^{th} bit block which is produced by a non-dummy paging channel message.

30. The system for detecting dummy paging channel message according to claim 29, wherein the minimum Hamming distance Dₘᵢₙ is greater than or equal to 4.

31. The system for detecting dummy paging channel message according to claim 23, wherein the reference dummy paging channel burst sequence comprises a first reference sequence and a second reference sequence, wherein the first reference sequence and the second reference sequence respectively comprise L bits, the L bits of the first reference sequence and the L bits of the second reference sequence respectively has L bit indexes, wherein the bit index of the i^{th} bit of the first reference sequence and the bit index of the i^{th} bit of the second reference sequence respectively are (i−1), wherein “i” and “L” are integers, and 0<=i<L.

32. The system for detecting dummy paging channel message according to claim 31, wherein the bit indexes comprise M common bit indexes and N residual bit indexes, wherein the bits in positions of the common bit indexes of the first reference sequence are the same as the bits in positions of the common bit indexes of the second reference sequence, wherein the bits in positions of the residual bit indexes of the first reference sequence are different from the bits in positions of the residual bit indexes of the second reference sequence, the determination unit comprises:
a common metric calculating unit, receiving the common bits of the first reference sequence from the reference sequence providing unit and receiving bits of the common bit indexes of the specific raw burst data from the receiving unit for comparing every bits in the positions of the common bit indexes of the specific raw burst data the with the bits in the positions of the common bit indexes of the first reference sequence to calculate a common metric.

33. The system for detecting dummy paging channel message according to claim 32, wherein the determination unit further comprises:
a common metric comparing unit, receiving the common metric from the common metric calculating unit for comparing the common metric with a common metric threshold value, wherein the determination signal is in the second state when the common metric is smaller than or equal to a common threshold value;
a residual metric calculating unit, receiving the residual bits of the first reference sequence from the reference sequence providing unit and receiving bits of the residual bit indexes of the specific raw burst data from the receiving unit, wherein the common metric comparing unit control the residual metric calculating unit for comparing every bits in the positions of the residual bit indexes of the specific raw burst data the with the bits in the positions of the residual bit indexes of the first reference sequence to calculate a first residual metric when the common metric is greater than the common threshold value;
a adder, receiving the first residual metric and the common metric to obtain the first metric; and
a sum comparing unit, receiving the first metric for comparing the first metric with the dummy paging channel threshold value to output the determination signal, wherein the determination signal is in the first state when the first metric is greater than the dummy paging channel threshold value.

34. The system for detecting dummy paging channel message according to claim 33, when the sum of the common metric and the first residual metric is smaller than or equal to the dummy paging channel threshold value, the system further comprising:
the residual metric calculating unit, receiving the residual bits of the second reference sequence from the reference sequence providing unit and receiving bits of the residual bit indexes of the specific raw burst data from the receiving unit, for comparing every bits in the positions of the residual bit indexes of the specific raw burst data the with the bits in the positions of the residual bit indexes of the second reference sequence to calculate a second residual metric; and
the adder, receiving the second residual metric and the common metric to obtain the second metric; and
the sum comparing unit, receiving the second metric for comparing the second metric with the dummy paging channel threshold value to output the determination signal, wherein the determination signal is in the second state when the second metric is smaller than or equal to the dummy paging channel threshold value, wherein the determination signal is in the first state when the first metric is greater than the dummy paging channel threshold value.

35. The system for detecting dummy paging channel message according to claim 34, wherein the first residual metric is represented as Score_{DB,1}, and a second residual metric is represented as Score_{DB,2}, the second residual metric can be calculated as following equation:
Score_{DB,2}=2A×N−Score_{DB,1},
wherein the bits of the specific raw burst data is an integer between A and −A, wherein “A” is a nature number,
wherein, when the sum of the common metric and the first residual metric is smaller than or equal to the dummy paging channel threshold value, the method further comprises:
calculating the second residual metric according to the equation:
Score_{DB,2}=2A×N−Score_{DB,1};
determining the raw burst data is the dummy paging channel message when a sum of the common metric and the second residual metric is greater than the dummy paging channel threshold value.

36. The system for detecting dummy paging channel message according to claim 31, further comprises:
a residual metric calculating unit, receiving the residual bits of the first reference sequence from the reference sequence providing unit and receiving bits of the residual bit indexes of the specific raw burst data from the receiving unit, comparing every bits in the positions of the residual bit indexes of the specific raw burst data the with the bits in the positions of the residual bit indexes of the first reference sequence to calculate a first residual metric;
a adder, receiving the first residual metric and the common metric to obtain the first metric; and
a sum comparing unit, receiving the first metric for comparing the first metric with the dummy paging channel threshold value to output the determination signal, wherein the determination signal is in the first state when the first metric is greater than the dummy paging channel threshold value.

37. The system for detecting dummy paging channel message according to claim 36, when the sum of the common metric and the first residual metric is smaller than or equal to the dummy paging channel threshold value, the system further comprising:
the residual metric calculating unit, receiving the residual bits of the second reference sequence from the reference sequence providing unit and receiving bits of the residual bit indexes of the specific raw burst data from the receiving unit, comparing every bits in the positions of the residual bit indexes of the specific raw burst data the with the bits in the positions of the residual bit indexes of the second reference sequence to calculate a second residual metric;
the adder, receiving the second residual metric and the common metric to obtain the second metric; and
the sum comparing unit, receiving the second metric for comparing the first metric with the dummy paging channel threshold value to output the determination signal, wherein the determination signal is in the first state when the second metric is greater than the dummy paging channel threshold value, wherein the determination signal is in the second state when the second metric is smaller than or equal to the dummy paging channel threshold value.

38. The system for detecting dummy paging channel message according to claim 37, wherein the first residual metric is represented as Score_{DB,1}, and a second residual metric is represented as Score_{DB,2}, the second residual metric can be calculated as following equation:
Score_{DB,2}=2A×N−Score_{DB,1},
wherein the bits of the specific raw burst data is an integer between A and −A, wherein “A” is a nature number,
wherein, when the sum of the common metric and the first residual metric is smaller than or equal to the dummy paging channel threshold value, the method further comprises:
calculating the second residual metric according to the equation:
Score_{DB,2}=2A×N−Score_{DB,1};
determining the raw burst data is the dummy paging channel message when a sum of the common metric and the second residual metric is greater than the dummy paging channel threshold value.
